(19) United States
(12) Patent Application Publication
(10) Pub. No.: US 2011/0265821 A1
(43) Pub. Date: Nov. 3, 2011

(54) TECHNIQUES FOR MAINTAINING A SUBSTRATE PROCESSING SYSTEM

(76) Inventors: Kiang Meng Tay, Sinapore (SG); Eugapore Wei Khal Mah, Sinapore (SG); Huay Meei Liew, Sinapore (SG); Teck Kwang Tay, Sinapore (SG); Chua Bong Lee, Sinapore (SG); Shi Chai Chong, Malaysia (MY); James Edward White, Gloucester, MA (US); Rudolph John Caruso, Gloucester, MA (US); Daniel Allen Simon, Gloucester, MA (US); Elie Eid Rahme, Gloucester, MA (US)

(21) Appl. No.: 13/143,011

(22) PCT Filed: Aug. 28, 2009
(86) PCT No.: PCT/SG09/00302

§ 371 Date: Jun. 30, 2011

(30) Foreign Application Priority Data
Jan. 6, 2009 (SG) 200900035-7

(51) Int. Cl. B08B 7/04; B05C 11/00

(52) U.S. Cl. 134/10; 118/504

(57) ABSTRACT

Techniques and systems for maintaining a plasma processing kit consisting of protection and shielding elements without causing damage are introduced. The elements may be made of aluminium, polysilicon and quartz and may be coated with silicon. The surfaces of the elemants show a specified roughness. Precision cleaning and recovery of the contamined kit components of a plasma doping (PLAD) system is used, to extend the life and reusability of the components. The methods described cover the stages of inspection, pre-cleaning, mechanical processing and texturing, post-cleaning, clean-room class cleaning and packaging of the components consisting of quartz, aluminium and/or silicon. Techniques described employ the combination of a variety of means (primarily chemical and mechanical) to achieve the desired levels of cleanliness. The result obtained by methods that include Inductively Coupled Plasma-Mass Spectrometry (ICP-MS) and Laser Particle Count affirm the efficacy of these techniques.

### 1. BACKGROUND OF THE INVENTION

1.1. Field of the Invention The present relates to techniques and systems for maintaining a substrate processing system, more particularly, to techniques and systems for maintaining a plasma processing system and its components without causing damage.

1.2. Description of the Related Art

Recently, much advancement is made in plasma doping (PLAD) for doping ionized impurity into a substrate has been made. Detailed description of the plasma doping method is provided in “Column of Shallow Junction Ion Doping of FIG. 30 of Front End Process in International Technology Roadmap for Semiconductors 2001 Edition (ITRS2001)” and “International Technology Roadmap for Semiconductors 2003 Edition (ITRS2003)” as a next-generation technology for implanting ions.

A system used in PLAD method may comprise a chamber including a dielectric window. The system may also comprise a plasma source for generating plasma; a platen positioned in the chamber and on which a substrate is positioned; and a bias voltage supply for applying a bias voltage to the platen and the substrate. The plasma source may be an inductively coupled plasma source, a capacitively coupled plasma source, a toroidal plasma source, a helicon plasma source, a DC plasma source, a remote plasma source, and a downstream plasma source. If the source is an inductively coupled plasma source, the source may comprise at least one antenna positioned proximate to the dielectric window of the chamber. The antenna may be coupled to an RF power source via an impedance matching network.

In operation, the substrate and the platen supporting the substrate may be positioned within the chamber. In addition, process gas containing desired species is introduced into the chamber. For example, di-borane, BF₃, or AsPH₃ may be introduced. Thereafter, RF current is applied to the antenna positioned outside the chamber. RF energy is then transferred from the antenna to the process gas via the dielectric window, converting the gas to plasma. The generated plasma immerses the substrate and contains ions of desired species. Thereafter, the substrate is applied with a bias voltage, and ions of desired species are attracted and, subsequently, introduced to the substrate. Compared to traditional beam-line ion implantation system, PLAD system is capable of implanting the substrate with ions at much higher dose and much lower energy.

The chamber wall of the conventional PLAD system may be made from aluminum, as aluminum is resistant to caustic process gas and as aluminum may be easily formed into desired shapes. The dielectric window, meanwhile, may be an Al₂O₃ dielectric window. Aluminum based chamber wall and dielectric window, although advantageous in some aspects, may serve as sources for metal contamination. For example, materials from the chamber wall and the dielectric window may be sputtered during PLAD process, and the sputtered materials may be introduced to substrate as undesired contaminants. To reduce the metal contamination, the PLAD system may contain several inert process kits designed to shield and protect the chamber from the process to reduce the metal contamination.

Meanwhile, other components contained in the chamber may be coated with inert, non-contaminating coating, such as silicon coating.

During these plasma doping processes, a BF₃ cleaning process is periodically used to maintain satisfactory process control conditions within the chamber. However, this often results in undesired effects of etching the process kits and chamber components and will cause some process residues such as unwanted metal dopant residues to deposit on the surfaces of the process kits in the chamber. Organic and inorganic by-products may also be deposited on the surfaces of these process kits and chamber parts. These plasma doping by-products may typically contain some concentration of organic and metallic or inorganic impurities. The composition of the process residues may depend upon the composition of the process gas, the material being doped, and the composition of material on the substrate. There are various types of contaminants that can be generally classified into the categories of metals, particles, and organics. The accumulation of these unwanted metal dopant residual by-products on the surface of the process kits and chamber parts may cause some problems in wafer fabrication such as contaminating the wafers with particles and organic and metallic impurities. As well as interfering with proper wafer fabrication by altering or stopping process chemistries, it may also cause the dose count electronics to calculate an inaccurate ion dose rate. These events are unpredictable thus adding some uncertainty to the plasma doping process since they have the potential to contaminate the wafer product.

As a result, after a certain number of wafers have been processed, these contaminated process kits must be periodically removed from the PLAD chamber and subjected to a precision recycle cleaning treatment (e.g. with a solvent or an acidic or basic solution or a variety of chemical and physical methods known in the art) before being reassembled into the PLAD chamber. However, in certain plasma doping processes, the process residues formed on the component have compositions that are difficult to clean. Consequently, they gradually accumulate on the component, eventually resulting in failure of the component.

In order to recycle clean the process kit and effectively remove the contamination as desired, it is inevitable that some quantity of the process kit's base material will also be removed during the recycle cleaning and recovery operation thus shortening the life of the process kits. After a number of cycles of PLAD processes followed by recycle cleaning and recovery operations, a sufficient quantity of process kit's base material may be removed such that the component no longer meets the acceptable tolerances to properly perform its intended function.

In view of the foregoing, the following is desirable: to design and provide a set of process kits and coated chamber components in the plasma-based ion implantation to overcome the above-described inadequacies and shortcomings; to have a reliable precision cleaning method to effectively and efficiently clean the process residues formed on the process kits, especially the chemically hard process residues; to have effective and appropriate cleaning methods, procedures and recipes so as to obtain clean process kits and chamber parts (with comparable cleanliness and structural integrity to the original equipment), maximum PLAD chamber performance, and minimum PLAD equipment downtime (while still maintaining acceptable processing yields for the processed wafer products); and to prevent or reduce damage to the process kits during the cleaning process. This is because, if incorrect precision cleaning methods are used, the process kits and chamber parts can be irreversibly damaged and the lifetime of the process kits and chamber parts significantly shortened.

### 1.3. REFERENCES

1. “International Technology Roadmap for Semiconductors 2001 Edition,” Front End Processes, pp. 223-225, 2001 Semiconductor Industry Association.
2. “International Technology Roadmap for Semiconductors 2003 Edition,” Front End Processes, Draft 6.1, Nov. 8, 2003, pp. 1-8.
3. ASTM D 1125—Test Methods for Electrical Conductivity and Resistivity of Water.
4. ASTM F24—Standard Method for Measuring and Counting Particulate Contamination on Surfaces.
5. FED-STD-209—Airborne Particulate Cleanliness Classes in Clean-rooms and Clean Zones.
6. IES-RP-CC018—Clean-room Housekeeping—Operating and Monitoring Procedures.
7. IES-RP-CC026—Clean-room Operations.
8. Bardina, J., Methods for Surface Particle Removal: Comparative Study, Particulate Science and Technology 6:121-131, 1988.
9. U.S. Pat. No. 4,912,065, Plasma doping method, Mar., 1990, Mizuno et al.
10. U.S. Pat. No. 4,937,205, Plasma doping process and apparatus therefore, Jun., 1990, Nakayama et al.
11. U.S. Pat. No. 5,851,906, Impurity doping method, Dec., 1998, Mizuno et al.
12. U.S. Pat. No. 6,403,410, Plasma doping system and plasma doping method, Jun., 2002, Ohira et al.
13. U.S. Pat. No. 6,435,196, Impurity processing apparatus and method for cleaning impurity processing apparatus, Aug., 2002, Satoh et al.
14. U.S.20050287776, Method of plasma doping, Dec., 2005, Sasaki et al.
15. U.S.20060183350, Process for fabricating semiconductor device, Aug., 2006, Kudo et al.
16. U.S.20070037367, Apparatus for plasma doping, Feb., 2007, Okumura et al.
17. U.S.20070048453, Systems and methods for plasma doping micro-feature workpieces, Mar., 2007, Qin et al.
18. U.S.20080160170, Technique for using an improved shield ring in plasma-based ion implantation, Jul. 2008, Miller et al.
19. U.S.20080090392, technique for improved damage control in a plasma doping (PLAD) ion implantation, Apr. 2008, Singh et al.

### 2. SUMMARY OF THE PRESENT INVENTION

The present invention provides a set of plasma doping process kits used for semiconductor material processing, whereby the set of plasma doping (PLAD) process kits are capable of shielding and protecting the interior surface of a plasma doping chamber from deterioration and unwanted particles, condensed contaminants and metal dopant materials generated in the chamber; the set of PLAD process kits comprising of;
(a) a chamber shield liner component made of aluminum material and having the inner surface coated with high purity silicon material, the silicon textured surface having a surface roughness average Ra from about 200 to 300 μin, and a coating thickness of about 200 to 400 μm. The aluminum base shield liner is a structure adapted to at least partially cover the interior surface in the chamber and comprises, in wt. %, at least 99.00% Al, ≦0.10% Cu, ≦0.10% Mg, ≦0.015% Mn, ≦0.02% Cr, ≦0.07% Fe, ≦0.025% Zn, ≦0.06% Si, ≦0.015% Ti, and ≦0.015% total residual elements. The shield liner structure comprises a textured interior surface of a high-purity silicon coating comprising at least 99.99 wt. % Si and ≦0.01 wt. % total transition elements;
(b) a cooling baffle plate component made of aluminum material and having a silicon coated textured surface, the silicon textured surface having a surface roughness average Ra from about 200 to 300 μin, and a coating thickness of about 150 to 300 μm. The aluminum base shield liner is a structure adapted to at least partially cover the interior surface in the chamber and comprises, in wt. %, at least 99.00% Al, ≦0.10% Cu, ≦0.10% Mg, ≦0.015% Mn, ≦0.02% Cr, ≦0.07% Fe, ≦0.025% Zn, ≦0.06% Si, ≦0.015% Ti, and ≦0.015% total residual elements. The cooling baffle plate structure comprises a textured interior surface of a high-purity silicon coating comprising at least 99.99 wt. % Si and ≦0.01 wt. % total transition elements;
(c) a platen shield ring component made of poly-silicon material comprising, in wt. %, at least 99.99% Si and/or ≦0.01% total transition elements and having a textured surface about the substrate, the textured surface having a surface roughness average Ra from about 10 to 20 μin, and a surface resistivity of less than 200 ohms;
(d) an RF window shield liner component, with a thickness of 0.080 inch, made of high-purity quartz material comprising, in wt. %, at least 99.99% Si and/or ≦0.01% total transition elements and having a textured surface, the textured surface having a surface roughness average Ra from about 10 to 30 μin;
(e) a top window shield liner component, with a thickness of 0.080 inch, made of high-purity quartz material comprising, in wt. %, at least 99.99% Si and/or ≦0.01% total transition elements and having a textured surface, the textured surface having a surface roughness average Ra from about 10 to 30 μin;
(f) a pedestal bushing shield liner component, with a thickness of 0.167 inch, made of high-purity quartz material comprising, in wt. %, at least 99.99% Si and/or ≦0.01% total transition elements and having a textured surface, the textured surface having a surface roughness average Ra from about 10 to 30 μin;

A method for precision recycle cleaning and recovery of a contaminated silicon coated aluminum process kit consisting of (a) chamber shield liner and (b) cooling baffle plate is employed and shall include the steps of:
(a) Silicon Coated Aluminum Process Kits Acceptance Inspection—During the incoming acceptance inspection, the silicon coated aluminum process kits which include (a) chamber shield liner, and (b) cooling baffle plate, are received from the customers and carefully placed on a clean inspection table. The silicon coated surfaces are then checked for damages and/or abnormalities. This is followed by an inspection of the silicon coated and non-coated surfaces for any pitting, scale, cracks and indentations, evidence of rolling, peeling or inclusions, de-laminations, discoloration and stains. Measurements of the (a) chamber shield liner, and (b) cooling baffle plate surface roughness and coating thickness are then taken and the conditions of the silicon coated aluminum process kits documented using guidelines established. Documentation will include digital photographs as well as logs of critical data.
(b) Silicon Coated Aluminum Process Kits Pre-cleaning—The silicon coated aluminum process kits may be pre-cleaned to remove foreign material. This method may include, but are not limited to: water-jetting the silicon coated aluminum process kits with pressured de-ionized water to remove any gross contamination, if necessary; or by carbon dioxide snow blasting, which involves directing a stream of small flakes of dry ice pellets to remove any residues by a combination of thermal shock and physical bombardment; or by immersion in acetone or Isopropyl Alcohol (IPA) followed by wipe to remove organic stains; or immersion in solution of Hydrogen Peroxide (H₂O₂) followed by rinse with de-ionized water and blow dry with filtered compressed dry air to remove excess water.
(c) Silicon Coated Aluminum Process Kits Mechanical Processing and Texturing—This is a precision mechanical cleaning and texturing method involving wet polishing and/or mechanical wet blasting. This method involves assessing the degree of contamination of the silicon coated aluminum surface and deciding the re-texturing procedure. For example, if severe contamination is observed on the silicon coated surface, re-texturing can begin with rough diamond grit pads or blasting beads until major dark contaminated stains and pitting are removed and a uniformly clean surface is achieved. If minor contamination is observed on the silicon coated kits, re-texturing can begin with medium diamond grit pads or blasting beads until a uniformly clean surface is achieved. In the case of blasting beads, masking of the non-coated chamber shield liner and cooling baffle plate surface with masking tapes, blasting plaster and aluminum foil is required to protect the non-coated surfaces from texturing damages. Selection and sequencing of diamond grit pad texturing media grades to be used are decided next. The silicon coated aluminum process kits are then securely placed on a turntable. The wet re-texturing procedure is done with suitable texturing media, such as silicon oxide beads, until deposition is removed and the surface roughness is achieved. Upon completion of wet blast, kits are then rinsed with de-ionized water and blown dry. Surface is then wiped until no visible transfer of residue onto the wiper is observed. Surface roughness of the silicon coated surface should be within 200 to 300 μin.
(d) Silicon Coated Aluminum Process Kits Post-cleaning—This is a post cleaning method to remove particles that are carried out after the texturing operation. The method may involve immersing the silicon coated aluminum process kits, which include (a) chamber shield liner, and (b) cooling baffle plate, in hot de-ionized water (in order to loosen particles that may be trapped in silicon coated kits), rinsing the kits with pressurized de-ionized water, followed by de-ionized water immersion in an overflowing (to facilitate fluid exchange) ultrasonic tank of sufficient power density for a period of time to remove particles from the silicon coated surface. Agitating the silicon coated process kits within the ultrasonic bath during the ultrasonic cleaning will help to remove trapped particles. Preferably, the silicon coated surfaces are then ice-blasted with a carbon dioxide blasting machine (carbon dioxide pellets). After that, the silicon coated process kits, including gas holes and profile, are rinsed with de-ionized water and then ultrasonically cleaned with a mixed solution of de-ionized water and isopropyl alcohol so as to remove soluble dopant contaminants. The method is continued by checking and inspecting the silicon coated process kits for damages/abnormalities (no chips, cracks, dents, discoloration, stains on surface) on both the silicon coated and non-coated surfaces. The surface roughness of the recovered silicon coated process kits should be within 200 to 300 μin. The coating thickness should be around 200 μm for the chamber shield liner and 150 μm for the baffle at minimum (without exposing the substrate)
(e) Silicon Coated Aluminum Process Kits Final Class 100 Cleaning, Baking and Certification—This is a final class 100 cleaning, baking and certification method to ensure and verify that the process kits which include (a) chamber shield liner, and (b) cooling baffle plate are free from organic/inorganic, metallic and particulate impurities; and that the physical surface morphology remains intact. The method generally includes rinsing the silicon coated aluminum process kits in an overflow (to facilitate effective fluid exchange) rinse tank containing ultra pure de-ionized water. Preferably, at least three rinses should be done to ensure removal of all chemical cleaning solutions. Alternatively, the silicon coated process kits may just be rinsed with de-ionized water. Then, kits are rinsed in an overflow ultrasonic tank of sufficient power density for a period of time. This is followed by a rinse with ultra pure de-ionized water within a class 100 clean-room. The silicon coated aluminum process kits are monitored by using a Liquid Particle Counter during the cleaning to ensure that the kits have achieved the predetermined cleanliness specification of <500,000 particles/cm². Next, the process kits are blown dry with ultra filtered compressed dry air within a class 100 clean-room environment. Having done this, the silicon coated aluminum process kits are subjected to high temperature sufficient to substantially remove all absorbed cleaning solutions as well as water vapor, chemicals and spout traps during the cleaning process. One method may involve hot air drying of the kits in a chamber at sufficient temperature over a period of time. Alternatively, kits are baked using a continuous nitrogen purged class 100 dust free air oven (or under a heat lamp) at sufficient temperature over a period of time with a fixed nitrogen inlet flow rate. The silicon coated aluminum process kits are then cooled in the oven with continuous pure nitrogen gas purge for a period of time within a class 100 clean-room before being taken out of the oven. An inspection is done on the silicon coated aluminum process kits' surface treatment areas (e.g. the coated surface, blasted surface, non-coated surface, etc.) to ensure that there is no peeling of the coated film as well as confirm the non-existence of stains, dirt, defects, fractures, scratches and dents (particularly, at the inner edge of the process kits). A surface particle count is taken with a QIII surface particle counter in a class 100 clean room environment to a specification of <1 particle/inch². Testing of the physical surface morphology of the silicon coated aluminum process kits is conducted to ensure that it is intact upon completion of the cleaning procedure. The results of inspection are certified per the guidelines established. The above-mentioned steps are repeated until the silicon coated aluminum process kits are clean and the surface particle count specification is met. Kits are then final inspected and the critical dimensions of the process kits documented. Documentation will include digital photographs as well as logs of critical data.
(f) Silicon Coated Aluminum Process Kits Packaging, Identification and Shipment—This is the packaging, identification and shipment method to ensure the silicon coated aluminum process kits which include (a) chamber shield liner, and (b) cooling baffle plate, are identified and packed carefully so that it remains clean and free from damage. The method generally includes packing and vacuum sealing the silicon coated aluminum process kits within a class 100 clean-room using a double-bag vacuum pack whereby the inner bag is a nylon bag with clean lint free material and the outer bag is an amide and silicon-free polyethylene bag. Bags are purged with pure nitrogen gas to evacuate any air. The vacuum pack is inspected for leaks and breakage to ensure a complete class 100 vacuum seal of the silicon coated aluminum process kits. The quantity of the silicon coated aluminum process kits is then confirmed and a correct packing list generated with proper labeling of the silicon coated aluminum process kits according to the delivery order. The kits are then packed into a proprietary-designed container box with cushions designated to properly protect and secure the silicon coated aluminum process kits before shipment to customer.

The silicon coated aluminum process kits which include (a) chamber shield liner, and (b) cooling baffle plate, are preferably inspected before and after precision cleaning and recovery to ensure that the recycled silicon coated aluminum process kits conform to product specifications. Inspection may include measuring, for example, dimensions (e.g. thickness), surface roughness (e.g. 200 to 300 μin), surface cleanliness and surface particle. Furthermore, the PLAD plasma doping chamber performance of the recovered silicon coated aluminum process kits are preferably tested to ensure that the recovered silicon coated aluminum process kits exhibit acceptable performance. Post-process operations include testing the silicon coated aluminum process kits in a fully-assembled PLAD equipment, and other post-process operations that will be apparent to those skilled in the art.

A method for precision recycle cleaning and recovery of a contaminated poly-silicon process kit consisting of a platen shield ring is employed and shall include the steps of:
(a) Poly-silicon Process Kits Acceptance Inspection—During the incoming acceptance inspection, the poly-silicon process kits which include the platen shield ring, are received from the customer and carefully placed on a clean inspection table and checked for surface damages and/or abnormalities. The poly-silicon surface is inspected for any pitting, scale, cracks and indentations, evidence of rolling, peeling or inclusions, discoloration and stains. Surface roughness and surface resistivity are then measured. The conditions of the poly-silicon process kits are documented as per guidelines established. Documentation will include digital photographs as well as logs of critical data.
(b) Poly-silicon Process Kits Pre-cleaning—The poly-silicon process kits may be pre-cleaned to remove foreign material with acetone and/or isopropyl alcohol. This method may include, but are not limited to: carbon dioxide snow blasting, which involves directing a stream of small flakes of dry ice pellets or pressurized liquid, to remove any residues by a combination of thermal shock and physical bombardment; or by immersion in acetone and followed by wipe to remove organic stains; or by immersion of the poly-silicon process kits in Hydrogen Peroxide (H₂O₂) solution for followed by a de-ionized water rinse, and blow dry with ultra filtered compressed dry air to remove excess water.
(c) Poly-silicon Process Kits Mechanical Processing and Texturing—This is a precision mechanical cleaning and texturing method involving wet polishing and/or mechanical wet blasting. This method involves assessing the degree of contamination of the platen shield ring poly-silicon surface and deciding the re-texturing procedure. For example, if severe contamination is observed on the platen shield ring poly-silicon surface, re-texturing can begin with rough diamond grit pads until major dark contaminated stains and pitting are removed and a uniformly clean surface is achieved. If minor contamination is observed on the platen shield ring poly-silicon surface, re-texturing can begin with medium diamond grit pads until a uniformly clean surface is achieved. Selection and sequencing of diamond pad texturing media grades to be used are decided next. The platen shield ring is placed securely on a turntable. The wet re-texturing procedure is begun on the poly-silicon surface of the platen shield ring using a first set of rough Foamex diamond grit pads followed by a re-texturing of the platen shield ring poly-silicon surface with a second set of medium Foamex diamond grit pads until major depositions have been removed and the surface roughness and surface resistivity are achieved. Kits are then water-jetted with pressurized de-ionized water and blown dry. The surface is wiped until no visible residue transfer onto the wiper is observed. The surface roughness of the platen shield ring should be 10 to 20 μin whilst the surface resistivity of the platen shield ring should be <200 ohms.
(d) Poly-silicon Process Kits Post-cleaning—This is a post cleaning method carried out to remove particles after the texturing operation. The method generally includes immersing the platen shield ring in hot de-ionized water in order to loosen particles that may be trapped in the platen shield ring. The platen shield ring is then immersed in an overflowing (to facilitate effective fluid exchange) de-ionized water ultrasonic tank of sufficient power density for a period of time at raised temperature to remove particles from the poly-silicon surface. Agitation of the poly-silicon platen shield ring within the ultrasonic bath during the ultrasonic cleaning helps remove trapped particles. Then, the platen shield ring, including gas holes and profile, is rinsed using pressurized de-ionized water and ultrasonically cleaned with a mixed solution of de-ionized water and isopropyl alcohol so as to remove soluble dopant contaminants. The platen shield ring is then inspected for poly-silicon surface damages/abnormalities (no chips, cracks, dents, discoloration, stains on surface). The surface roughness of the recovered poly-silicon platen shield ring should be between 10 and 20 μin. The surface resistivity should be <200 ohms.
(e) Poly-silicon Process Kits Final Class 100 Cleaning, Baking and Certification—This is a final class 100 cleaning, baking and certification method to ensure and verify that the process kits are free from organic/inorganic, metallic and particulate impurities and that the physical surface morphology remains intact. The method generally includes rinsing the poly-silicon process kits in an overflow (to facilitate effective fluid exchange) rinse tank containing ultra pure de-ionized water followed by another rinse in an overflowing ultra pure de-ionized water ultrasonic rinse tank of sufficient power density for a period of time within a class 100 clean-room. The poly-silicon process kits are monitored by using a Liquid Particle Counter during the cleaning to ensure that the kits have achieved the predetermined cleanliness specification of <500,000 particles/cm². The procedure is repeated if the platen shield ring has not attained the specified levels of cleanliness. Next, the process kits are blown dry with ultra filtered compressed dry air within a class 100 clean-room environment. Having done this, the poly-silicon process kits are subjected to high temperature sufficient to substantially remove all absorbed cleaning solutions as well as water vapor, chemicals and spout traps during the cleaning process. One method may involve hot air drying of the kits in a chamber at sufficient temperature for a period of time. Alternatively, kits are baked using a continuous nitrogen purged class 100 dust free air oven (or under a heat lamp) at sufficient temperature for a period of time with a fixed nitrogen inlet flow rate. The poly-silicon process kits are then cooled in the oven with continuous pure nitrogen gas purge for a period of time within a class 100 clean-room before being taken out of the oven. An inspection is done on the poly-silicon process kits' surface to ensure the non-existence of stains, dirt, defects, fractures, scratches and dents (particularly, at the edges of the process kits). A surface particle count is taken with a QIII surface particle counter in a class 100 clean room environment to a specification of <1 particle/inch². Testing of the physical surface morphology of the poly-silicon process kits is conducted to ensure that it is intact upon completion of the cleaning procedure. The results of inspection are certified per the guidelines established. The above-mentioned steps are repeated until the poly-silicon process kits are clean and the surface particle count specification is met. Kits are then final inspected and the critical dimensions of the process kits documented. Documentation will include digital photographs as well as logs of critical data.
(f) Poly-silicon Process Kits Packaging, Identification and Shipment—This is the packaging, identification and shipment method to ensure the poly-silicon process kits are identified and packed carefully so that it remains clean and free from damage. The method generally includes packing and vacuum sealing the poly-silicon process kits within a class 100 clean-room using a double-bag vacuum pack whereby the inner bag is a nylon bag with clean lint free material and the outer bag is an amide and silicon-free polyethylene bag. Bags are purged with pure nitrogen gas to evacuate any air. The vacuum pack is inspected for leaks and breakage to ensure a complete class 100 vacuum seal of the poly-silicon process kits. The quantity of the poly-silicon process kits is then confirmed and a correct packing list generated with proper labeling of the poly-silicon process kits according to the delivery order.

The kits are then packed into a proprietary-designed container box with cushions designated to properly protect and secure the poly-silicon process kits before shipment to customer.

The platen shield ring is preferably inspected before and after precision cleaning and recovery to ensure that the recycled platen shield ring conforms to product specifications. Inspection may include measuring, for example, dimensions (e.g. thickness), silicon surface resistivity (multi meter with alligator clips to a specification of <200 ohms.), surface roughness (e.g. 10 to 20 μin), surface cleanliness and surface particle count. Furthermore, the PLAD plasma doping chamber performance of the recovered platen shield ring are preferably tested to ensure that the recovered platen shield ring exhibit acceptable performance. Post-process operations include testing the platen shield ring in a fully-assembled PLAD equipment, and other post-process operations that will be apparent to those skilled in the art.

A method for precision recycle cleaning and recovery of a contaminated quartz process kit consisting of (a) an RF window shield liner; (b) a top window shield liner; and (c) a pedestal bushing shield liner is employed and shall include the steps of:
(a) Quartz Process Kits Acceptance Inspection—During the incoming acceptance inspection, the quartz process kits which include (a) an RF window shield liner; (b) a top window shield liner; (c) a pedestal bushing shield liner, are received from the customer and carefully placed on a clean inspection table and checked for quartz surface damages and/or abnormalities. The quartz surfaces are inspected for any pitting, scale, cracks and indentations, deformation, dents, discoloration and stains. The measurement of the quartz surface roughness is taken and the conditions of the quartz process kits documented as per guidelines established. Documentation will include digital photographs as well as logs of critical data.
(b) Quartz Process Kits Pre-cleaning—The quartz process kits may be pre-cleaned to remove foreign material with acetone and/or isopropyl alcohol. This method may include, but are not limited to: water-jetting the quartz process kits (held in a Teflon fixture) with pressured de-ionized water to remove any gross contamination (if necessary); or by immersing the quartz process kits (held in a Teflon fixture) in acetone solution to remove organic stains. Lint-free polyester sealed wipers are used to clean the quartz process kits if necessary. Quartz process kits are then spray rinsed with pressurized de-ionized water and blown dry with ultra filtered compressed dry air to remove excess water.
(c) Quartz Process Kits Chemical Processing within a Controlled Environment—This is a precision chemical cleaning method to remove organic/inorganic and metallic deposited contaminants within a class 10,000 controlled environment. The method generally includes immersing or submerging the quartz process kits (held in a Teflon fixture) into a chemical tank with an aqueous mixed-chemical solution of Hydrogen Peroxide, Ammonium Hydroxide and Water (H₂O₂:NH₄OH:H₂O) of a suitable predetermined volume ratio based on the total volume of the solution. Quartz process kits are then spray rinsed with pressurized de-ionized water and blown dry with ultra filtered compressed dry air. Next, the quartz process kits (held a Teflon fixture) are immersed or submerged in an aqueous chemical solution containing Hydrochloric Acid (HCl) of a suitable predetermined volume ratio based on the total volume of the solution. Quartz process kits are then spray rinsed with pressurized de-ionized water and blown dry with ultra filtered compressed dry air. Then, the quartz process kits (held in a Teflon fixture) are immersed and submerged into a tank of an aqueous mixed-chemical solution comprising of Nitric Acid (HNO₃) and Hydrogen Fluoride (HF) aqueous mixed-acid solution of a suitable predetermined volume ratio based on the total volume of the solution. Quartz process kits are then spray rinsed with pressurized de-ionized water and blown dry with ultra filtered compressed dry air. The quality of the quartz process kits are determined by checking the surface cleanliness and condition of the quartz process kits. Quartz process kits are also inspected for signs of contamination and faulty cleaning or damage. The process is repeated until the quartz process kits are clean. The quartz process kits are transported to the class 100 clean room environment for the final cleaning in PE tanks filled with ultra pure de-ionized water.
(d) Quartz Process Kits Final Class 100 Cleaning, Baking and Certification—This is a final class 100 cleaning, baking and certification method to ensure and verify that the process kits are free from organic/inorganic, metallic and particulate impurities and that the physical surface morphology remains intact. The method generally includes rinsing the process kits with ultra pure de-ionized water followed by another rinse in an overflow (to facilitate effective fluid exchange) rinse tank containing ultra pure de-ionized water to ensure removal of all chemical cleaning solutions. The process is continued by rinsing the quartz process kits (held in a Teflon fixture) in an overflow rinse tank containing ultra pure de-ionized (resistivity of 18 Mega Ohms/cm or higher) water of sufficient power density for a period of time within a class 100 clean-room. The quartz process kits are monitored by using a Liquid Particle Counter during the cleaning to ensure that the kits have achieved the predetermined cleanliness specification of <200,000 particles/cm². After ultrasonic cleaning, the quartz process kits are rinsed with pressurized ultra pure de-ionized water and then blown dry with pressurized ultra filtered nitrogen gas within a class 100 clean-room environment. This procedure is repeated until quartz process kits have attained the specified levels of cleanliness. Then, the quartz process kits are subjected to high temperature sufficient to substantially remove all absorbed cleaning solutions as well as water vapor, chemicals and spout traps during the cleaning process. One method may involve hot air drying of the kits in a chamber at sufficient temperature for a period of time. Alternatively, kits are baked using a continuous nitrogen purged class 100 dust free air oven (or under a heat lamp) at sufficient temperature for a period of time. After baking, the quartz process kits are cooled in the oven for a period of time before being taken out of the oven and then inspected and checked for surface cleanliness and signs of contamination, faulty cleaning or damage. Surface particle count is measured to a specification of <1 particle/inch² to ensure the surface cleanliness of the quartz. Testing of the quartz process kits' physical surface morphology using Inductively Coupled Plasma-Mass Spectrometry (ICP-MS) method is done to ensure that it is intact after the cleaning procedure is completed. The results of inspection are certified per the guidelines established. The above-mentioned steps are repeated until the quartz process kits are clean and the surface particle count specification is met. Kits are then final inspected and the critical dimensions of the process kits documented. Documentation will include digital photographs as well as logs of critical data.
(e) Quartz Process Kits Packaging, Identification and Shipment—This is the packaging, identification and shipment method to ensure the quartz process kits are identified and packed carefully so that it remains clean and free from damage. The method generally includes packing and vacuum sealing the quartz process kits within a class 100 clean-room using a double-bag vacuum pack whereby the inner bag is a nylon bag with clean lint free material and the outer bag is an amide and silicon-free polyethylene bag. Bags are purged with pure nitrogen gas to evacuate any air. The vacuum pack is inspected for leaks and breakage to ensure a complete class 100 vacuum seal of the poly-silicon process kits. The quantity of the quartz process kits is then confirmed and a correct packing list generated with proper labeling of the quartz process kits according to the delivery order. The kits are then packed into a proprietary-designed container box with cushions designated to properly protect and secure the quartz process kits before shipment to customer.

The quartz process kit that consists of (a) an RF window shield liner; (b) a top window shield liner; and (c) a pedestal bushing shield liner, are preferably inspected before and after precision cleaning and recovery to ensure that the recycled quartz process kits conform to product specifications. Inspection may include measuring, for example, dimensions (e.g. thickness), surface roughness (e.g. 10 to 30 μin), surface cleanliness and surface particle. Furthermore, the PLAD plasma doping chamber performance of the recovered quartz process kits are preferably tested to ensure that the recovered quartz process kits exhibit acceptable performance. Post-process operations include testing the quartz process kits in a fully-assembled PLAD equipment, and other post-process operations that will be apparent to those skilled in the art.

Accordingly, several objects and advantages of the present invention are of great benefit. For example, the present invention advantageously provides a set of plasma doping (PLAD) process kits capable of protecting the interior surface of a PLAD chamber from deterioration and unwanted metal dopant materials generated in the chamber. These PLAD process kits will provide more accurate process control, minimized contamination levels and reduced consumable cost associated with high volume production using the PLAD system. In addition, the present invention advantageously removes the organic, inorganic and metallic impurity by-products without damaging the original process kit material or surface morphology. This will further offer a reliable, quantifiable and efficient means to attain consistent quality and maximize PLAD system availability, performance efficiency, and rate of quality for optimal system effectiveness and improved wafer fabrication productivity. In addition to an improvement in the cleaning effect by using the cleaning method of the present invention, manufacturing time and cost can be decreased since a number of process kits can be simultaneously processed. Therefore, by implementing this invention, engineers can increase recycle cleaning process yields and process quality and performance, achieve faster time-to-delivery, boost customer satisfaction, etc

Further objects and advantages of this invention will become apparent from a consideration of the drawings and the ensuing description. Other aspects, features and advantages of the invention will be more apparent from the ensuing disclosure and appended claims.

### 3. BRIEF DESCRIPTION OF THE DRAWINGS

The above and other advantages of the invention will become more apparent from the following descriptions taken in conjunction with the accompanying drawings wherein like references refer to like parts and wherein:

FIG. 1 illustrates a schematic cross-sectional view of the prior art of the plasma doping chamber without process kits.

FIG. 2 illustrates a schematic cross-sectional view of a plasma doping chamber with the process kits having textured internal surfaces according to one embodiment of the invention.

FIG. 3 illustrates an exploded view of the process kits having textured internal surfaces according to one embodiment of the invention.

FIG. 4 illustrates a schematic view of the chamber shield liner made of aluminum material and having the inner surface coated with silicon material according to one embodiment of the invention.

FIG. 5 illustrates a schematic view of the cooling baffle plate made of aluminum material and having a silicon-coated textured surface according to one embodiment of the invention.

FIG. 6 illustrates a schematic view of the platen shield ring made of silicon material and having a textured surface according to one embodiment of the invention.

FIG. 7 illustrates a schematic view of the RF window shield liner made of quartz and having a textured surface according to one embodiment of the invention.

FIG. 8 illustrates a schematic view of the top window shield liner made of quartz and having a textured surface according to one embodiment of the invention.

FIG. 9 illustrates a schematic view of the pedestal bushing shield liner made of quartz and having a textured surface according to one embodiment of the invention.

FIG. 10 illustrates a flowchart that summarizes the methods in this invention for the precision recycle cleaning and recovery of a contaminated PLAD process kit.

FIG. 11 illustrates a flowchart of a cleaning process (with valid example process parameters), in accordance with one aspect of the present invention, to remove resistant organic and metallic impurities from a partially silicon coated metal kit.

FIG. 12 illustrates a flowchart showing a cleaning process (with valid example process parameters), in accordance with one aspect of the present invention to remove particle and metallic impurities from a textured high purity poly-silicon surface.

FIG. 13 illustrates a flowchart showing a cleaning process (with valid example process parameters), in accordance with one aspect of the present invention to remove particle and metallic impurities from a textured high purity quartz surface.

FIG. 14A shows exemplary used silicon coated chamber shield liner before recovery, while FIG. 14B shows exemplary silicon coated chamber shield liner after recovery. Dark stained regions in FIG. 14A are no longer observed after recovery as seen in FIG. 14B.

FIG. 15A shows exemplary used silicon coated baffle cooling plate before recovery, while FIG. 15B shows exemplary silicon coated baffle cooling plate after recovery. Dark stained regions in FIG. 15A are no longer observed after recovery as seen in FIG. 15B.

FIG. 16A shows exemplary used platen shield ring cooling plate before recovery, while FIG. 16B shows exemplary platen shield ring after recovery. Rainbow/Dark stained regions in FIG. 16A are no longer observed after recovery as seen in FIG. 16B.

FIG. 17A shows exemplary used quartz liner (in this case, the pedestal bushing shield liner) before recovery, while FIG. 17B shows exemplary quartz liner after recovery. Dark stained regions in FIG. 17A are no longer observed after recovery as seen in FIG. 17B.

FIG. 18 shows resistivity of the silicon surface of a ring shield liner before and after precision cleaning and recovery method of the present invention.

FIG. 19 shows the cleanliness level of the quartz surface and the effectiveness of the present invention using Inductively Coupled Plasma-Mass Spectrometry (ICP-MS) method.

FIG. 20 shows the cleanliness level of the quartz surface and the effectiveness of the present invention using the Laser Particle Count method.

### 4. DETAILED DESCRIPTION OF THE INVENTION

The present invention provides a set of process kits with well-textured surfaces such that they can be used to attract and adhere various particles, condensed materials and contaminants generated during substrate processing. The invention further provides the precision recycle cleaning and recovery of the various process kits. Embodiments of the present invention will be described in further detail with reference to the accompanying drawings. Accordingly, the foregoing discussion is intended to be illustrative only, and not limiting; the invention is limited and defined only by the following claims and equivalents thereto.

In the following description, numerous specific details are set forth in order to provide a thorough understanding of the present invention. It will be apparent, however, to those skilled in the art, that the present invention may be practiced without some or all of these specific details. In some instances, well known process steps have not been described in detail so as not to obscure the present invention unnecessarily. In particular, these include most of the detailed manufacturing techniques for the fabrication of the process kits and the analytical quality control methods used to measure critical dimensions and cleanliness levels.

All given process parameters that accompany the process steps and those parameters that are to be found within the body of text in Section 4 pertaining to the present invention are for illustrative purpose only. As such, those of ordinary skill in the art will recognize that said process parameters may not be construed as non-variables.

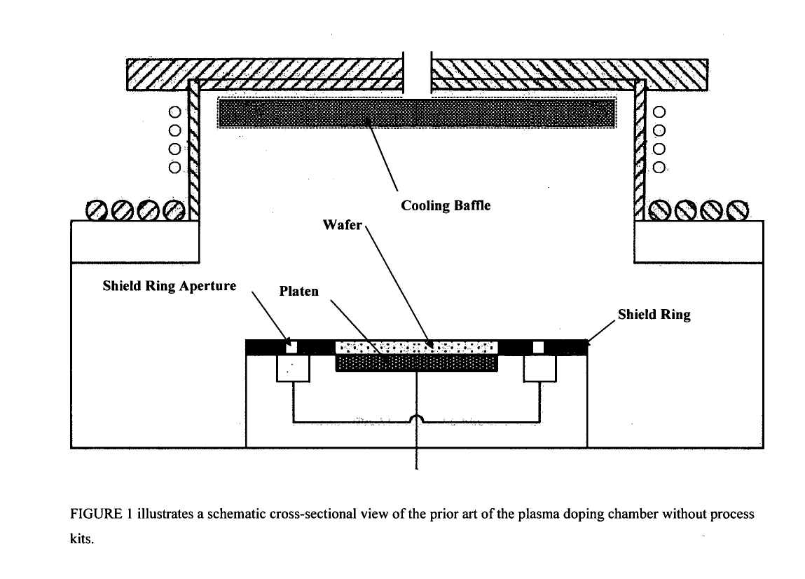

In the prior art as shown in FIG. 1, the PLAD systems typically include plasma chambers that are made of aluminum because aluminum is resistant to many process gasses and because aluminum can be easily formed and machined into the desired shapes. Many plasma doping systems also include Al₂O₃ dielectric windows for passing RF and microwave signals from external antennas into the plasma chamber. The presence of the aluminum and the aluminum based materials can result in metal contaminating the substrate being doped. It is generally desirable to reduce metal contamination in plasma immersion ion implantation processes to an area density of less than 5×10¹¹/cm². Since aluminum is commonly used as a base metal for many plasma chambers, it is known in the art that aluminum contamination can result from sputtering of aluminum plasma chamber walls and Al₂O₃ dielectric material, which is commonly used to form dielectric windows and other structures within plasma chambers.

Thus, in order to reduce metal contamination caused by the plasma doping processes, some process kits are designed to shield and protect the chamber from the process to reduce the metal contamination. Furthermore, other exposed elements such as hollow electrodes may be coated with a non-contaminating material, such as silicon, or include some non-metal based material. One of the reasons for using process kits to shield and protect the doping chamber is to prevent the deterioration of the doping chamber caused by the NF₃ plasma exposure during plasma doping operation.

During these plasma doping processes, a BF₃ cleaning process is periodically used to maintain satisfactory process control conditions within the chamber. However, this often results in undesired effects of etching the process kits and chamber components and will cause some process residues such as unwanted metal dopant residues to deposit on the surfaces of the process kits in the chamber. Organic and inorganic by-products may also be deposited on the surfaces of these process kits and chamber parts. These plasma doping by-products may typically contain some concentration of organic and metallic or inorganic impurities. The composition of the process residues may depend upon the composition of the process gas, the material being doped, and the composition of material on the substrate. There are various types of contaminants. They can be generally classified into the categories of metals, particles, and organics. The accumulation of these unwanted metal dopant residue by-products on the surfaces of the process kits and chamber parts may cause some problems in wafer fabrication such as contaminating the wafers with particles and organic and metallic impurities. As well as interfere with proper wafer fabrication by altering or stopping process chemistries, and may also cause the dose count electronics to calculate an inaccurate ion dose rate. These events are unpredictable thereby adding uncertainty to the plasma doping process since they have the potential to contaminate the wafer product.

### 4.1. The Unique Process Kits for Plasma Doping.

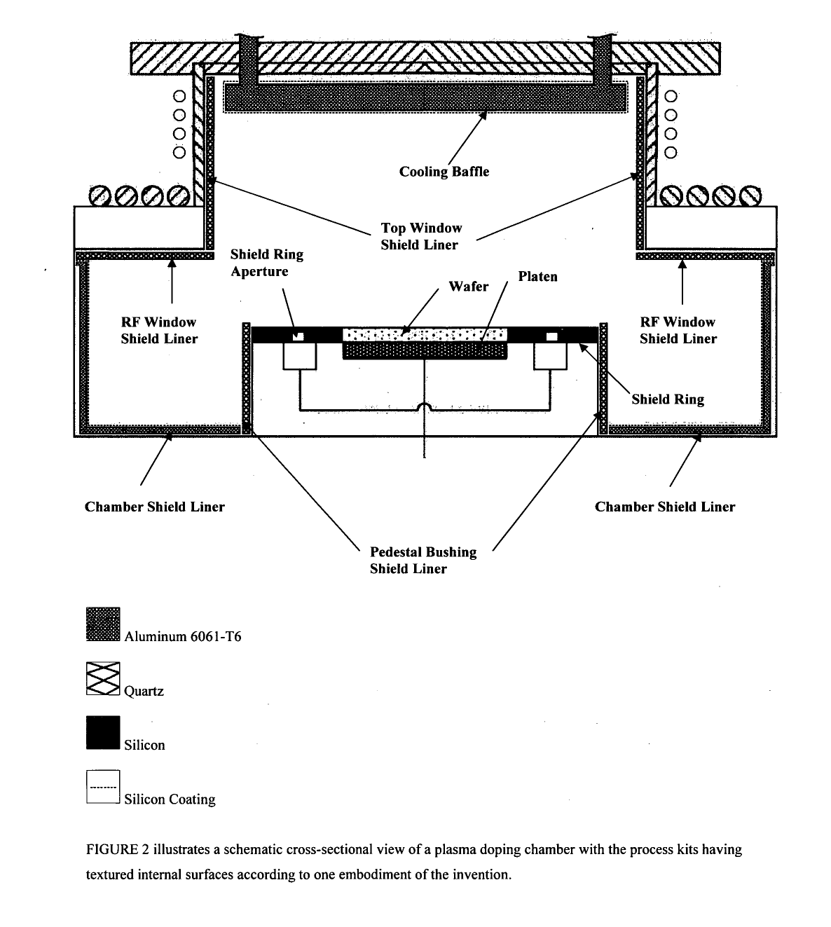

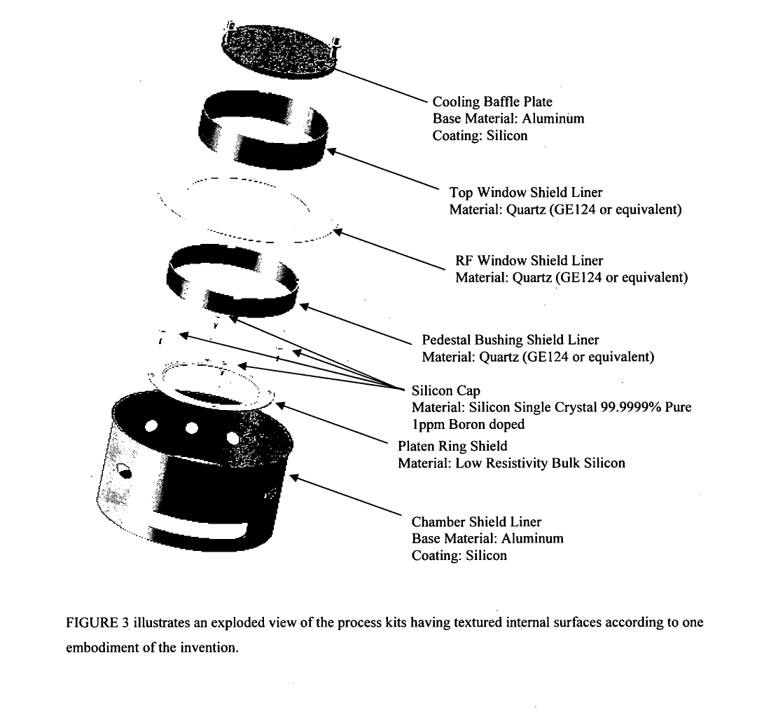

In accordance with one aspect of the present invention as shown in FIG. 2 and FIG. 3, the aforementioned Plasma Doping (PLAD) system consist of plasma reaction chamber wherein processing of a semiconductor wafer can be carried out will include a set of six process kits consisting of one chamber component and five shield liners capable of shielding an interior surface in a PLAD chamber from unwanted metal dopants material generated in the chamber. These chamber shield liners comprise of a circular structure adapted to at least cover the interior surface in the PLAD chamber. These process kits are preferably comprised of metal-based material, quartz and single crystalline silicon materials for ease of manufacturing. However, most of the metal-based liners are thermally coated with a layer of silicon material to create a textured surface to cause the unwanted metal dopants material to adhere thereto in order to minimize contamination during the doping operation.

The present invention, as shown in FIG. 2 and FIG. 3, provides a set of plasma doping (PLAD) process kit capable of protecting the interior surface of a PLAD chamber from deterioration and unwanted metal dopant materials generated in the chamber comprising:
(a) a chamber shield liner component made of aluminum material and having the inner surface coated with high purity silicon material, the silicon textured surface having a surface roughness average Ra from about 200 to 300 μin, and a coating thickness of about 200 to 400 μm. The aluminum base shield liner is a structure adapted to at least partially cover the interior surface in the chamber and comprises, in wt. %, at least 99.00% Al, ≦0.10% Cu, ≦0.10% Mg, ≦0.015% Mn, ≦0.02% Cr, ≦0.07% Fe, ≦0.025% Zn, ≦0.06% Si, ≦0.015% Ti, and ≦0.015% total residual elements. The shield liner structure comprises a textured interior surface of a high-purity silicon coating comprising at least 99.99 wt. % Si and ≦0.01 wt. % total transition elements;
(b) a cooling baffle plate component made of aluminum material and having a silicon coated textured surface, the silicon textured surface having a surface roughness average Ra from about 200 to 300 μin, and a coating thickness of about 150 to 300 μm. The aluminum base shield liner is a structure adapted to at least partially cover the interior surface in the chamber and comprises, in wt. %, at least 99.00% Al, ≦0.10% Cu, ≦0.10% Mg, ≦0.015% Mn, ≦0.02% Cr, ≦0.07% Fe, ≦0.025% Zn, ≦0.06% Si, ≦0.015% Ti, and ≦0.015% total residual elements. The cooling baffle plate structure comprises a textured interior surface of a high-purity silicon coating comprising at least 99.99 wt. % Si and ≦0.01 wt. % total transition elements;
(c) a platen shield ring component made of poly-silicon material comprising, in wt. %, at least 99.99% Si and/or ≦0.01% total transition elements and having a textured surface about the substrate, the textured surface having a surface roughness average Ra from about 10 to 20 μin, and a surface resistivity of less than 200 ohms;
(d) an RF window shield liner component, with a thickness of 0.080 inch, made of high-purity quartz material comprising, in wt. %, at least 99.99% Si and/or ≦0.01% total transition elements and having a textured surface, the textured surface having a surface roughness average Ra from about 10 to 30 μin;
(e) a top window shield liner component, with a thickness of 0.080 inch, made of high-purity quartz material comprising, in wt. %, at least 99.99% Si and/or ≦0.01% total transition elements and having a textured surface, the textured surface having a surface roughness average Ra from about 10 to 30 μin;
(f) a pedestal bushing shield liner component, with a thickness of 0.167 inch, made of high-purity quartz material comprising, in wt. %, at least 99.99% Si and/or ≦0.01% total transition elements and having a textured surface, the textured surface having a surface roughness average Ra from about 10 to 30 μin;

In accordance with one aspect of the present invention as shown in FIG. 2 and FIG. 3, it has been discovered that at least some of these shield liners that are exposed to the plasma have a non-metal and plasma-resistant textured surface that enhances the adhesion of dopant deposits that accumulate on the components. The PLAD process kit typically includes some shield liners that at least cover the interior chamber surface and shields the interior chamber surface from the accumulation of doped material generated in the doping operation. The surface being shielding may be, for example, an exposed surface of another component, an interior chamber wall, or an edge of the wafer support assembly as is apparent from FIG. 2 and FIG. 3. These shield liners can also serve to direct or redirect the doped ions toward the wafer as well as protect an interior surface.

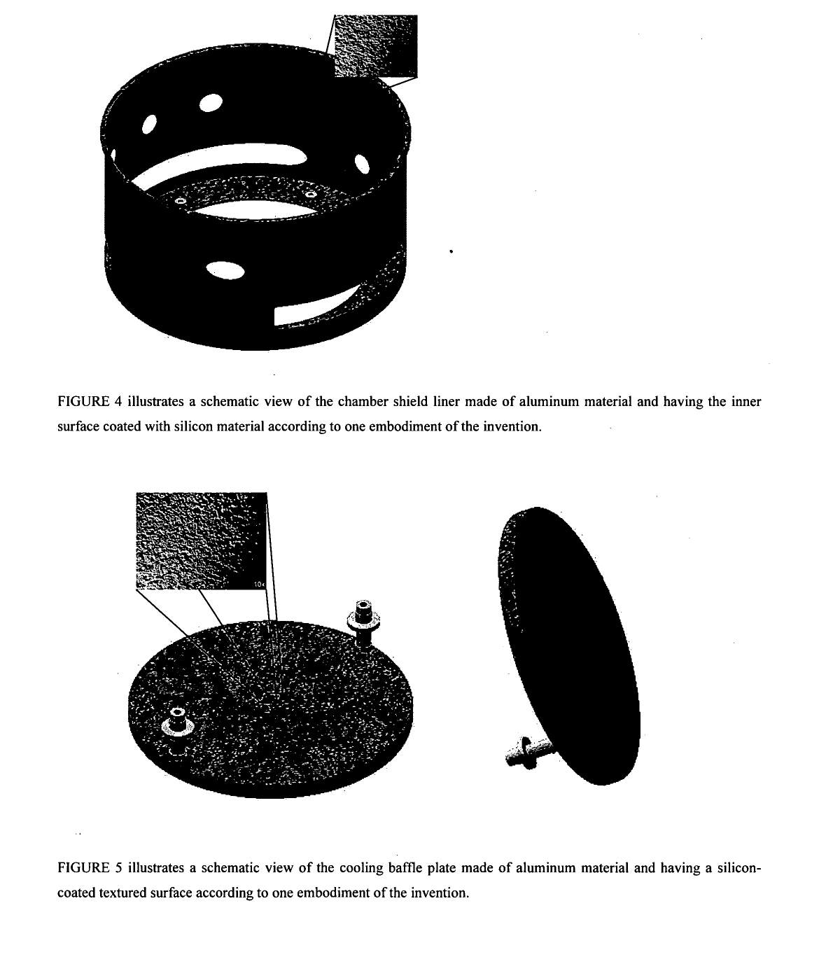

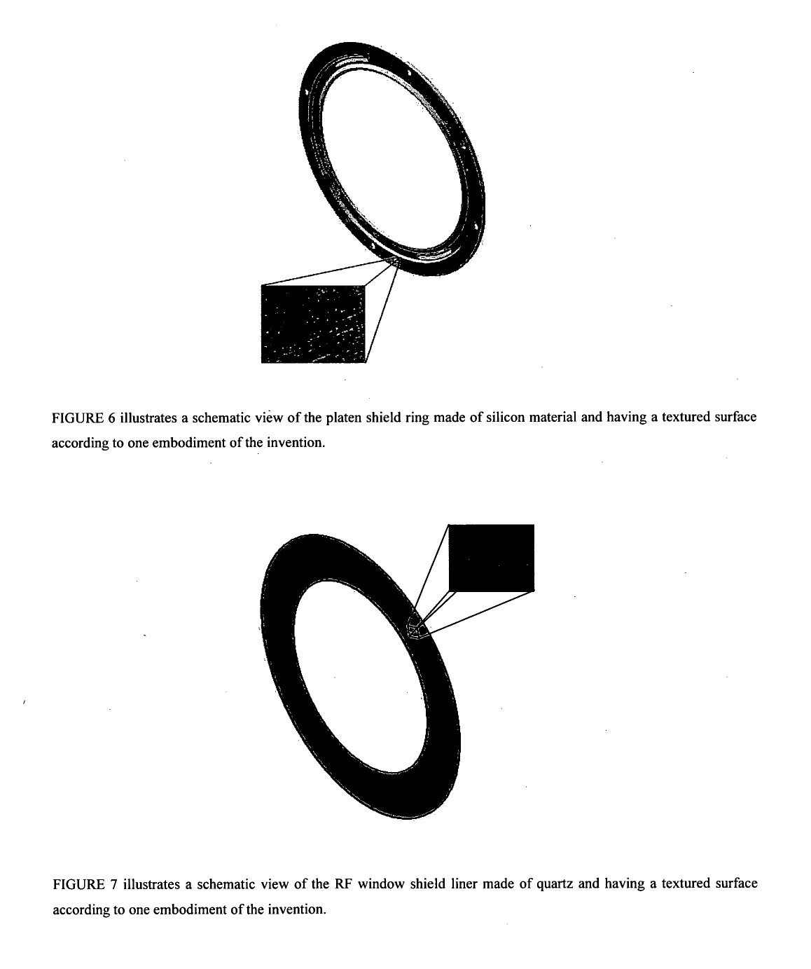

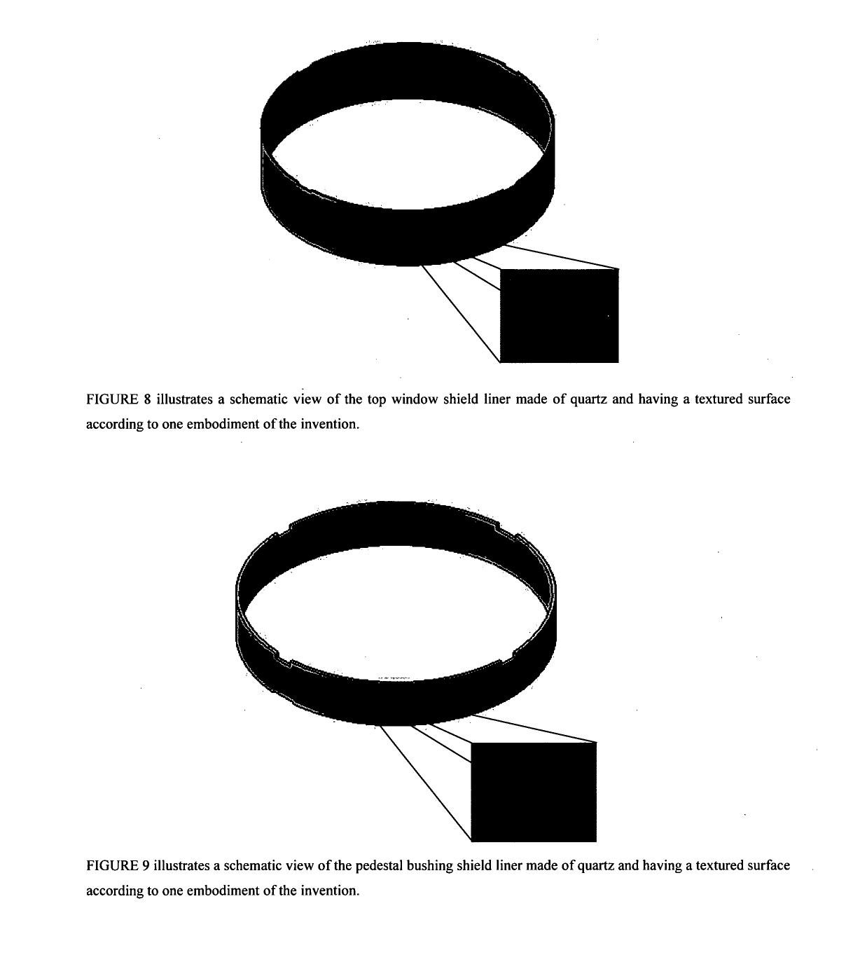

In accordance with one aspect of the present invention, as shown in FIG. 2 and FIG. 3, the aforementioned PLAD plasma doping shield liners may be consist of a chamber shield liner made of aluminum material having the inner surface coated with silicon material (the shield liner being positioned adjacent to the sidewalls and bottom sidewall). This chamber shield liner includes a lower shielding portion that shields a lower portion of the sidewall and bottom wall from the plasma and process gas. The chamber shield liner serve to shield and reduce contamination of the doped material on the walls of the PLAD chamber and also serve to redirect the gas flow in the chamber to a region above the wafer. In the version shown in FIG. 2, FIG. 3 and FIG. 4, the chamber shield liner has an L-shape cross-section with a vertical leg abutting into a horizontally extending leg.

In accordance with another aspect of the present invention, as shown in FIG. 2 and FIG. 3, the aforementioned PLAD plasma doping shield liner may also be a platen shield ring that encircles the wafer and covers at least a portion of the upper surface of the support. For example, the platen shield ring may be shaped as an annular ring covering an edge of a platen (e-clamp or electrostatic chuck) on the support to reduce the exposure of the platen (e-clamp or electrostatic chuck) to the plasma and also prevent deposition of doped material onto the platen (e-clamp or electrostatic chuck). In one version, the platen shield ring at least surrounds the wafer and has a unique edge and aperture-defining device (circular arc-shaped with a faraday cup positioned under the aperture) having a radial inner portion upon which the peripheral edge of the wafer is placed. This will provide more accurate process control, minimized contamination levels and reduced consumables cost during high volume wafer fabrication. (U.S. Patent No. 2008/0160170 by Miller et al.).

In accordance with one aspect of the present invention, as shown in FIG. 2 and FIG. 3, the aforementioned PLAD plasma doping shield liner may be a cooling baffle plate made of aluminum material having a silicon-coated textured surface, and the cooling baffle plate being positioned adjacent to the top sidewall. This cooling baffle plate serves an upper shielding portion that shields the top sidewall or ceiling from the process gas. This cooling baffle plate also serves to shield and reduce deposition of the doped material on the top sidewall of the chamber and redirect the gas flow in the chamber to a region above the substrate.

In accordance with another aspect of the present invention, as shown in FIG. 2 and FIG. 3, the aforementioned PLAD plasma doping shield liner may also be a top window shield liner made of flamed polished quartz having a textured surface, and that top window shield liner covers at least a portion of the upper surface of the PLAD chamber from the plasma and process gas. The top window shield liner serves to shield and reduce contamination of the doped material on the walls of the PLAD chamber and redirect the gas flow in the chamber to a region above the wafer. For example, the top window shield liner may be shaped as an annular quartz tube covering an edge of the cooling baffle plate on the upper chamber to reduce the exposure of the upper side chamber wall to the plasma and also prevent deposition of doped material onto the upper side chamber wall. In one version, the top window shield liner at least surrounds the cooling baffle plate and has a unique edge upon which the peripheral edge of the cooling baffle plate is protected. This will lend itself to more accurate process control, minimized contamination levels and reduced consumables cost during high volume wafer fabrication.

In accordance with another aspect of the present invention, as shown in FIG. 2 and FIG. 3, the aforementioned PLAD plasma doping shield liner may also be an RF window shield liner made of flamed polished quartz having a textured surface; the RF window shield liner encircles the wafer and covers at least a portion of the upper surface of the PLAD chamber from the plasma and process gas. The RF window shield liner serves to shield and reduce contamination of the doped material on the walls of the PLAD chamber and redirect the gas flow in the chamber to a region above the wafer. For example, the RF window shield liner may be shaped as an annular quartz ring covering an edge of the chamber shield liner on the upper chamber to reduce the exposure of the upper side chamber wall to the plasma and prevent deposition of doped material onto the upper side chamber wall. In one version, the RF window shield liner at least surrounds the top window shield liner and chamber shield liner. It has a unique edge upon which the peripheral edge of the chamber shield liner is protected. This will lend itself to more accurate process control, minimized contamination levels and reduced consumables cost during high volume wafer fabrication.

In accordance with another aspect of the present invention, as shown in FIG. 2 and FIG. 3, the aforementioned PLAD plasma doping shield liner may also be a pedestal bushing shield liner made of flamed polished quartz having a textured surface. The pedestal bushing shield liner encircles the platen and covers at least a portion of the edge of a platen (e-clamp or electrostatic chuck) on the support structure from the plasma and process gas. For example, the pedestal bushing shield liner may be shaped as an annular quartz tube covering an edge of a platen (e-clamp or electrostatic chuck) on the support structure to reduce the exposure of the platen (e-clamp or electrostatic chuck) to the plasma and also prevent deposition of doped material onto the platen (e-clamp or electrostatic chuck). In one version, the pedestal bushing shield liner at least surrounds the shield ring and has a unique edge upon which the peripheral edge of the shield ring is protected. This will lend itself to more accurate process control, minimized contamination levels and reduced consumables cost during high volume wafer fabrication.

In accordance with another aspect of the present invention, it has been discovered that the number of particles generated on the wafer during doping is substantially reduced when the exposed surfaces of the process kits are entirely covered by the non-metallic textured surface. The textured surface has a unique surface morphology suitable for the improved adhesion and retention of doped material on the surface. This improved retention reduces “contamination” of the material from the surface and thus reduces the generation of contaminant particles on the wafer. Thus, the textured surface of the process kits improves production yields.

The textured surface has unique surface properties that provide a surface morphology that improves adhesion and retention of doped material. This surface morphology may be measured by an average surface roughness and coating thickness. The average roughness is the mean of the absolute values of the displacements from the mean line of the peaks and valleys of the roughness features along a surface. Surface roughness is usually measured in micro-inches (μm) or dimensional root mean square (RMS) by means of a profilometer.

The textured surface may be, for example, a silicon textured coating that covers an underlying surface of the component and is textured to have the desired contaminant adhesion characteristics. In the first version, the chamber shield liner component comprises an underlying aluminum structure formed from aluminum material into the desired shape and then coated by a coating process that provides the desired textured surface. For example, a chamber shield liner structure can be fabricated by a flow forming method where the aluminum material is flow formed into the desired shape, and then precision machined to the actual size and dimension. The metallic materials that are suitable for flow forming the underlying structure may comprise, for example, stainless steel or aluminum.

Once the underlying chamber shield liner structure is flow formed, the coating having the textured surface is formed over the surface, as shown in FIG. 4. The coating should have a strong bond with the underlying surface and have the desired surface texture. The texturing of the surface can be performed by any of the film coating processes known in the art, such as thermal spray coating, plating, bead blasting, grit blasting and electrostatic spraying. For example, arc spraying, flame spraying, powder flame spraying, wire flame spraying arid plasma spraying, can be used to adjust the surface roughness of the silicon material layer coated by the above-mentioned film coating processes according to embodiments of the invention.

In one version, the coatings may be of silicon. For example, in one version, the chamber shield liner and cooling baffle plate comprise of the aluminum-based underlying structure covered by a layer of textured silicon coating or other ceramic coating. The textured coating may be applied to a thickness suitable to reduce erosion of surfaces in the chamber.

4.2. Plasma Doping Process kits Precision Recycle Cleaning and Recovery Method.

The process kits used in Plasma Doping (PLAD) chamber will deteriorate after a large number of RF hours, in part due to the formation of unwanted metal dopant materials generated in the chamber. A non-contiguous unwanted metal dopant deposit can form on the plasma-exposed surface, for example, the surface of a chamber shield liner, cooling baffle plate, platen shield ring, RF window shield liner top window shield liner and pedestal bushing shield liner during a main doping step for doping a semiconductor wafer.

As a result, after a certain number of wafers have been processed, these “contaminated” process kits must be periodically removed from the PLAD chamber and subjected to a precision recycle cleaning treatment and recovery process (e.g. with exact chemistry solvents and solutions; or an acidic or basic solution; or a combination of chemical and physical methods known in the art) before being reassembled into the PLAD chamber. However, in certain plasma doping processes, the process residues formed on the process kits have a polymeric composition that is very difficult to clean and remove. Consequently, they gradually accumulate on the component, eventually resulting in failure of the component. Thus, this “contamination”, if not properly and adequately cleaned and removed, could cause abnormal chemical reactions, false readings of instruments, or inaccurate measurements which could ultimately result in a malfunction or total failure of the PLAD system.

This contamination is difficult to remove because these metallic contaminants form chemical bonds with the surfaces of the PLAD process kits, thus bonding the metal impurities to the surfaces of the kits. These chemical bonds may include the by-product of the plasma doping process and this will create increased difficulty in cleaning the kits without the use of exact chemistries and cleaning method. If the wrong chemistries and cleaning methods are used, the PLAD process kits can be irreversibly damaged or insufficiently cleaned. Thus, precision cleaning and recovery techniques are necessary to remove undesirable dopant contamination from process kit surfaces prior to service. In addition, the present invention advantageously removes the organic, inorganic and metallic impurity by-products without damaging the original process kit material or surface morphology. This will further offer a reliable, quantifiable and efficient means to attain consistent quality and maximize PLAD system availability, performance efficiency, and rate of quality for optimal system effectiveness and improved wafer fabrication productivity. In addition to an improvement in the cleaning effect by using the cleaning method of the present invention, manufacturing time and cost can be decreased since a number of process kits can be simultaneously processed. Therefore, by implementing this invention, engineers can increase recycle cleaning process yields and process quality and performance, achieve faster time-to-delivery, boost customer satisfaction, etc.

This present invention includes a method and apparatus for precision recycle cleaning and recovery of PLAD process kits using unique selective chemistry and mechanical processing. Preferably, the PLAD process kits are cleaned and recovered using both (a) mechanical cleaning, such as high pressure water-jet cleaning, compressed-dry-air blowing, bead blasting, carbon dioxide cleaning, controlled thermal oxidation and oven air baking, etc., as well as (b) selective chemical stripping by exposing it to the different mixed-acids and chemical solvents in order to remove the organic/inorganic and metallic impurity by-products, stains, adhesions and contaminant by-products on the PLAD process kits without damaging or destroying the surface properties of the process kits. The present invention provides a method and apparatus for completely removing all process organic/inorganic and metallic impurity by-product deposits as well as metallic contaminants from PLAD process kit material.

In accordance with one aspect of the present invention, the contaminated PLAD process kits can be removed in the most affordable and effective way by the use of unique selective chemistries and mechanical methods, and/or a combination thereof. This cleaning technique is particularly novel as applied to the cleaning of PLAD process kits, for example: the chamber shield liner made of aluminum material with silicon coating, the cooling baffle plate made of aluminum material with silicon coating, a shield ring made of poly-silicon material, an RF window shield liner made of flame polished quartz, a top window shield liner made of flame polished quartz and a pedestal bushing shield liner made of flame polished quartz.

Specifically, the cleaning chemistries contain: a water soluble organic solvent, a high purity concentrated acid or its corresponding salts, water and optional additives such as chelating agents and surfactants that may be added to the cleaning solution to enhance the efficiency and chemical reaction rate. In one embodiment, the mixed solution of Ammonium Hydroxide (NH₄OH) and Hydrogen Peroxide (H₂O₂) has the ability to remove both organic and metal contamination. Ammonia is an excellent complexing agent that forms stable complex metal ions with many transition metals and thus helps improve metal removal efficiency. Hydrogen peroxide (H₂O₂) is a strong oxidizer, which helps to remove not only organic contaminants, but also metal contaminants and can oxidize transition metals to higher chemical states to form soluble complexes with ammonia and form chelating complexes with many metal ions to improve cleaning efficiency. The ultra-pure de-ionized water (UPW), preferably, has a resistivity 18 Mega Ohms/cm or higher. In another embodiment, the mixed chemical solution of Hydrofluoric Acid (HF) and Nitric Acid (HNO₃) has the ability to remove both organic and metal contaminants from quartz surfaces. Hydrofluoric Acid and Nitric Acid helps etch the silicon surface. These precision cleaning chemistries of the present invention significantly reduce organic and metal contamination as well as particles contamination without damaging the base materials and affecting the desired surface properties. These cleaning chemistries have been shown to have very high recoveries and efficiencies, especially on silicon surfaces, quartz, and poly-silicon. This is because, through the use of these cleaning chemistries together with the cleaning procedures, the PLAD process kits can be recycled and recovered by controlling the temperature and time to remove all the sub-surface contamination.

In accordance with another aspect of the present invention, the aforementioned contamination on quartz surfaces of the PLAD process kits can be removed by a unique controlled thermal oxidation technique. This technique can efficiently remove contaminants by subjecting the contaminated quartz kits to a controlled high temperature ramp profile of 200° C. every 90 minutes to up to 800° C. (holding for 3 hours depending on how thick or resistant the organic contaminants are to cleaning) and then cooling down to room temperature over a cooling profile of 200° C. every 2 hours. In one embodiment, this formula has been shown to be quite effective in cleaning metal ions from high purity quartz. In another embodiment, this formula has been shown to be quite effective in cleaning metal ions from high purity poly-silicon and single crystal silicon surface.

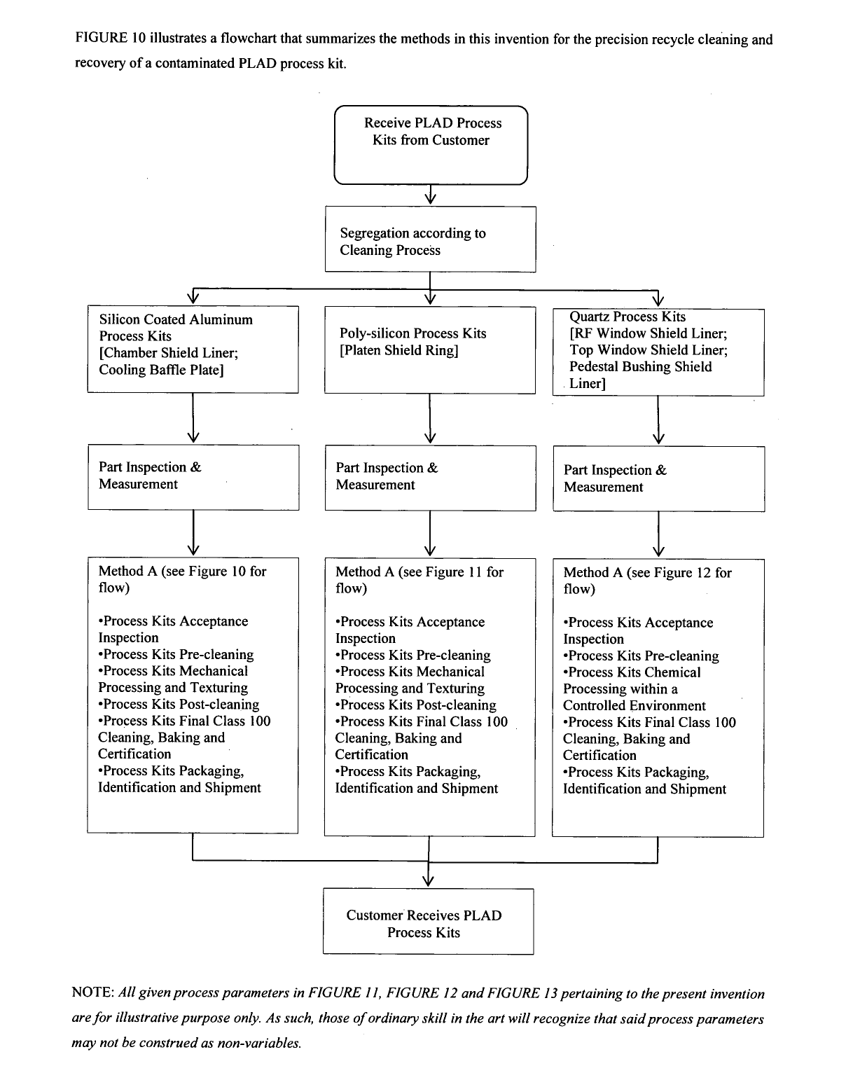

FIG. 10 illustrates a flowchart showing an overview of the PLAD process kit recycle cleaning and recovery processes. In an initial start operation, pre-process operations are performed which may include determining the particular characteristics of the kit to be processed and other pre-process operations that will be apparent to those skilled in the art. Beforehand, the PLAD process kits are separated and classified into different base materials, namely a chamber shield liner made of aluminum material with silicon coating, a cooling baffle plate made of aluminum material with silicon coating, a shield ring made of poly-silicon material, an RF window shield liner made of flame polished quartz, a top window shield liner made of flame polished quartz and a pedestal bushing shield liner made of flame polished quartz.

### 4.3. Method for Precision Cleaning and Recovery of Silicon Coated Aluminum Process Kit, for Example, the Chamber Shield Liner and the Cooling Baffle Plate.

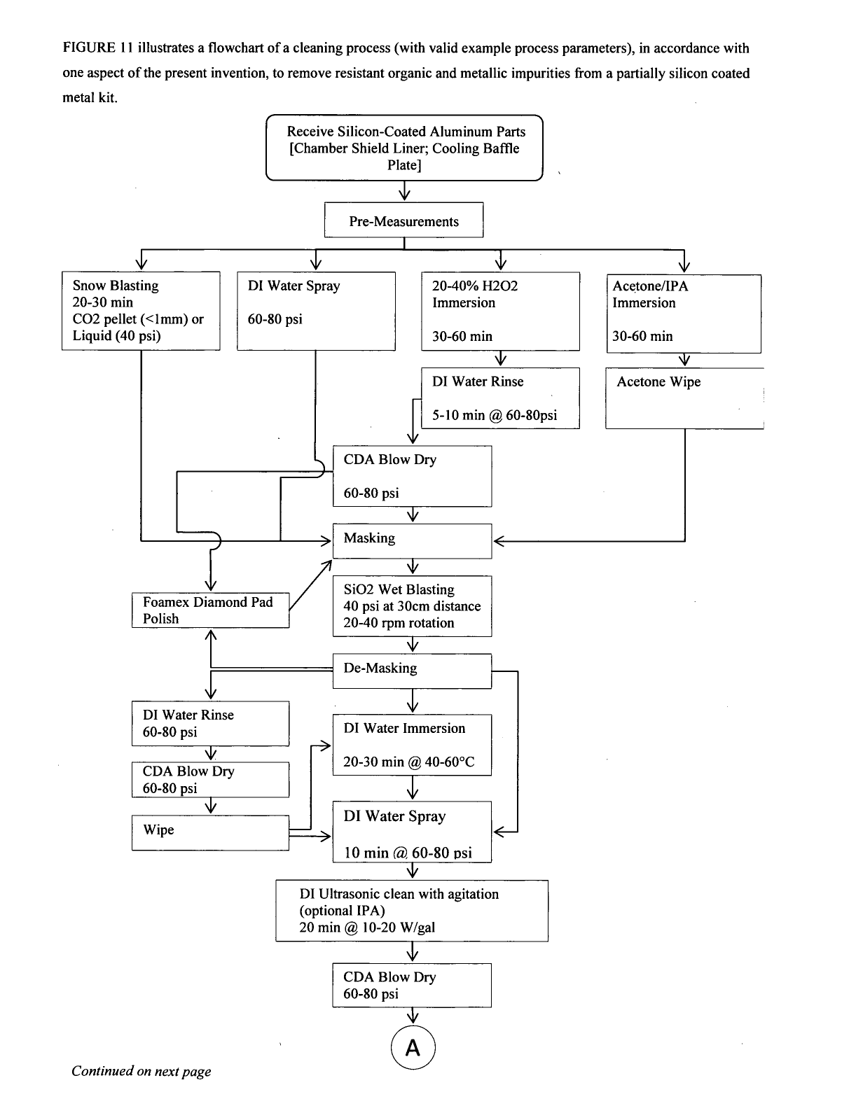

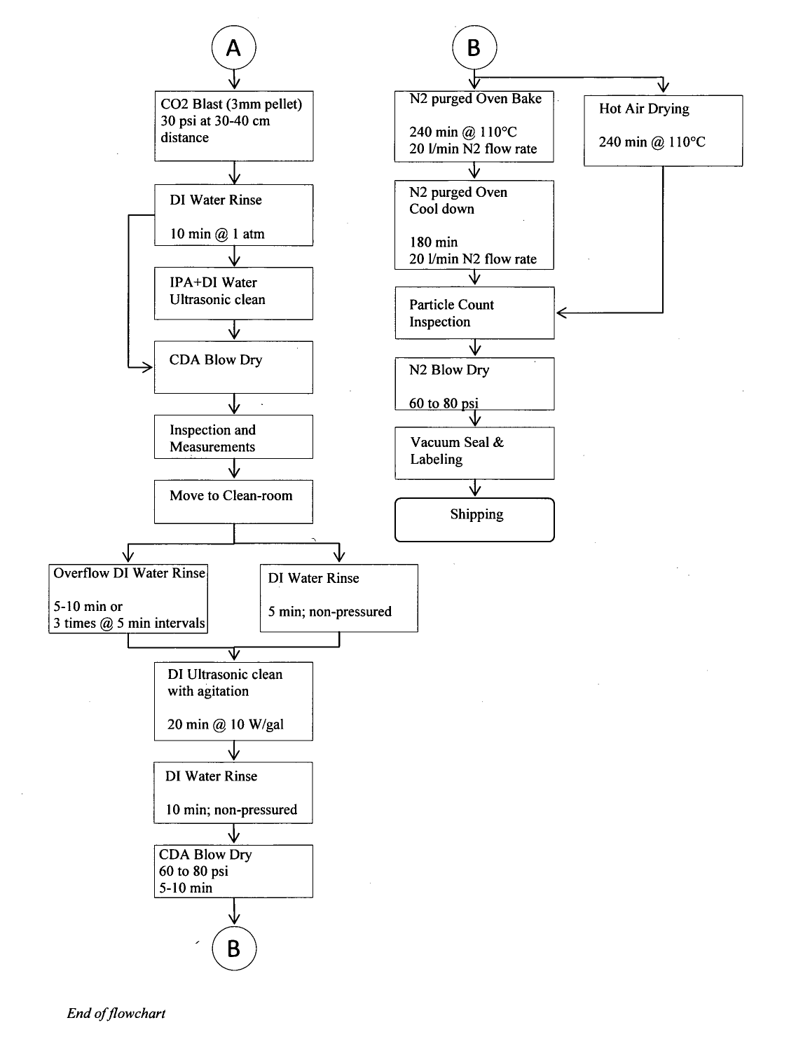

FIG. 11 illustrates the flowchart (with valid example parameters) showing a precision cleaning and recovery method, in accordance with one aspect of the present invention, to clean and remove contaminants from a silicon textured surface of the chamber shield liner (which is of aluminum structure with silicon coated internally) and cooling baffle plate (which is of aluminum structure with silicon coated on the surface). Note that all given process parameters in FIG. 11 pertaining to the present invention are for illustrative purpose only. As such, those of ordinary skilled in the art will recognize that said process parameters may not be construed as non-variables.

In one embodiment of the present invention, a best-known-method (BKM) for recycle cleaning and recovery process of contaminated silicon coated aluminum process kits, for example, the PLAD chamber shield liner and cooling baffle plate, shall include the steps of:

During the incoming acceptance inspection, the chamber shield liner and cooling baffle plate, are received from the customers and carefully placed on a clean inspection table. The silicon coated surfaces are then checked for damages and/or abnormalities. This is followed by an inspection of the silicon coated and non-coated surfaces for any pitting, scale, cracks and indentations, evidence of rolling, peeling or inclusions, de-laminations, discoloration and stains. Signs of these are documented and reported to the customer representative. Preferably, the inspection table is wiped with isopropyl alcohol prior to measurements and the surface roughness and coating thickness profile measured at predetermined locations. The conditions of the process kits are documented using guidelines established. Documentation includes digital photographs as well as logs of critical data.

The kit may be pre-cleaned to remove foreign materials. Such pre-cleaning may include, but are not limited to: water-jetting the silicon coated aluminum process kits with pressured de-ionized water at about 60 to 80 psi for 5 to 10 minutes to remove any gross contamination, if necessary; or by carbon dioxide snow blasting, which involves directing a stream of small flakes of dry ice pellets (pellet size range <1 mm) or liquid with a pressure of 30 to 40 psi for about 20 to 30 minutes, to remove any residues by a combination of thermal shock and physical bombardment;

Prior to mechanical re-texturing and recovery, the silicon coated kits may be cleaned with acetone and/or isopropyl alcohol. For example, the silicon coated kits may be immersed in acetone for 30 to 60 minutes followed by wipe to remove organic stains; or immersed in a solution of 30% to 40% Hydrogen Peroxide (H₂O₂) for 30 to 60 minutes followed by a spray rinse with de-ionized water for 5 minutes at 60 to 80 psi and blow dry with compressed dry air (ultra-filtered to 0.1 pm or better and pressured about 60 to 80 psi) to remove excess water.

Preferably, the silicon surface is re-textured and recovered using a wet polishing and/or mechanical blasting method. This method involves masking of the non-coated chamber shield liner surface (and cooling baffle plate surface) with masking tapes, blasting plaster and aluminum foil to protect the non-coated surfaces from texturing damages. The re-texturing procedure (i.e. the selection and sequencing of the texturing media used) depends on the degree of contamination of the silicon surface. If severe contamination is observed on the silicon coated surface, re-texturing can begin with rough diamond grit pads (having a mean diamond grain diameter falling within the range of 0.06 μm to 0.50 μm and a Mohs hardness falling within the range of 6 to 8) until a uniformly clean surface is achieved. If minor contamination is observed on the silicon coated kits, re-texturing can begin with medium diamond grit pads (having a mean diamond grain diameter falling within the range of 0.10 μm to 0.50 μm and a Mohs hardness not lower than 9) until a uniformly clean surface is achieved. Fine diamond grit pads (having a mean grain diameter falling within the range of 0.10 μm to 2.0 μm) may be used to finish off the step. Subsequent re-texturing can be with a wet blasting method. Alternatively, silicon coated kits may be re-textured and recovered using the wet blasting method. The wet re-texturing procedure is carried out with suitable texturing media, such as silicon oxide beads (150 to 200 μm), at a pressure of 40 psi and a distance of 30 cm until deposition is removed and the surface roughness is achieved. During re-texturing, the silicon coated kits are attached to a specially designed turntable with special fixtures, with a rotational speed of about 20-40 rpm. A uniform, but not strong, force is preferably applied during re-texturing, as a strong force may cause damage to the silicon surface of the silicon coated kits. The non-coated surface is cleaned with medium diamond grit pad #220 and/or rough diamond grit pad #140.

Following re-texturing, the silicon coated kits are preferably rinsed with de-ionized water and blown dry. The surface roughness of the silicon coated kits may be measured using, for example, a surface roughness meter (non-contact laser or stylus). The surface roughness of the kit is preferably approximately 200 to 300 μin. The coating thickness should be roughly 200 μm for the chamber shield liner and 150 μm baffle at minimum (without exposing the substrate).

Following the re-texturing process, the silicon coated kits are preferably immersed in de-ionized water at 40° C. to 60° C. for 20 to 30 minutes in order to loosen particles that may be trapped in the silicon coated kits. The silicon coated kits may then be rinsed with de-ionized water (resistivity 2 to 16 Mega Ohms/cm or higher) at 60 to 80 psi. The silicon coated kits may be ultrasonically cleaned in an overflowing (to facilitate effective fluid exchange) de-ionized water ultrasonic tank with a power density set at 10 to 20 Watts/gallon for 20 minutes to remove particles from the surface of the silicon coated kits. The silicon coated kits may be moved up and down within the ultrasonic bath during the ultrasonic cleaning in order to help remove trapped particles. In addition, the silicon coated surfaces are then (preferably) ice-blasted with a carbon dioxide blasting machine (carbon dioxide pellets) at 30 psi at a distance of 30 to 40 cm from the surface. Furthermore, the silicon coated kits, including gas outlets and joints or mounting holes of the silicon coated kits, may be rinsed with de-ionized water (resistivity 2 to16 Mega Ohms/cm or higher) for 10 minutes and then ultrasonically cleaned with a mixed solution of de-ionized water and isopropyl alcohol so as to remove soluble dopant contaminants. Following the ultrasonic cleaning, the silicon coated kits are checked and inspected for damages/abnormalities on surface. Preferably, the inspection table is cleaned with isopropyl alcohol prior to any measurements. The silicon coated kits are subjected to the measurement of the surface roughness and coating thickness profile at predetermined locations.

Preferably, the silicon coated kits are moved to a class 100 clean room environment for the final cleaning. The kits are first rinsed in an overflow (to facilitate effective fluid exchange) rinse tank containing ultra pure de-ionized water (resistivity of 18 Mega Ohms/cm or higher) for about 5-10 minutes. Preferably, at least three rinses at 5 minute intervals should be done to ensure removal of all chemical cleaning solutions. Alternatively, the silicon coated process kits may be rinsed with de-ionized water (resistivity of 18 Mega Ohms/cm or higher) for 5 minutes. Next, the kits are rinsed in an overflow ultrasonic tank with power density set at 10 Watts/gallon for 20 minutes followed by a 10 minute rinse with ultra pure de-ionized (resistivity of 18 Mega Ohms/cm or higher) water within a class 100 clean-room. The ultra pure de-ionized water is ultra-filtered to remove all particles down to 0.1 μm or better. The silicon coated surface is checked and inspected every 10 minutes to make sure there is no staining or coating degradation. The kits are then blown dry with high pressured (about 60 to 80 psi) nitrogen gas (dry, oil-free, and ultra-filtered to 0.1 μm or better) for 5 to 10 minutes within a class 100 clean-room environment.

In this final cleaning operation, the silicon coated kits are monitored during the cleaning by using a Liquid Particle Counter. This monitoring method is used to ensure that the kit has achieved the predetermined cleanliness specification. When the particle count level as measured by the LPC technique is less than 500,000 particles per cm², the kit is then rinsed in de-ionized water and thereafter purged dry with filtered pure nitrogen gas or compressed dry air. This cleaning process can be repeated if the kit has not attained the specified levels of cleanliness.

Preferably, the silicon coated kits are subjected to high temperature sufficient to substantially remove all absorbed cleaning solutions as well as water vapor, chemicals and spout traps during the cleaning process. One method may involve hot air drying of the kits in a chamber at 110° C. for about 240 minutes. Alternatively, kits are baked using a continuous nitrogen purged class 100 dust free air oven (or under a heat lamp) at 110° C. for 240 minutes with nitrogen inlet flow rate of 20 litres per minute. The class 100 dust free air oven should be of sufficient size to accommodate the kits and the kits should be kept away from the oven wall with jigs and fixtures. The silicon coated kits are cooled in the oven with continuous pure nitrogen gas purge for 180 minutes at a flow rate of 20 litres per minute within a class 100 clean-room before being taken out.

Following the final cleaning and baking, the silicon coated kits are checked and inspected for particle contamination with a surface particle count inspection using a QIII surface particle counter (to a specification of <1 particle/inch²) under class 100 clean room environments. In addition, the kits are inspected for possible stains, dirt, defects, fractures, scratches and dents with particular attention to the inner silicon coating of the chamber shield liner.

Finally, the kits are packed using double bags within a class 100 clean-room environment and vacuum sealed. The inner bag is a nylon bag of thickness 0.1 mm with clean lint free material and the outer bag is an amide and silicon-free polyethylene bag of thickness 0.12 mm. Bags are purged with pure nitrogen gas to evacuate any air. These steps are to ensure that they remain clean and free from damage. All sealing faces and/or knife edges are protected with clean used metal gaskets where possible. All ports are covered with strong clean new aluminum foil and plastic covers.

The silicon coated kits are preferably inspected before and after precision cleaning and recovery to ensure that the recycled silicon coated kits conform to product specifications. Inspection may include measuring, for example, dimensions (e.g. thickness), surface roughness (e.g. 200 to 300 μin), surface cleanliness and surface particle count. Furthermore, the PLAD plasma doping chamber performance of the recovered silicon coated aluminum process kits are preferably tested to ensure that the recovered silicon coated aluminum process kits exhibit acceptable performance. Post-process operations include testing the silicon coated aluminum process kits in a fully-assembled PLAD equipment, and other post-process operations that will be apparent to those skilled in the art.

FIG. 14A shows exemplary used silicon coated chamber shield liner before recovery, while FIG. 14B shows exemplary silicon coated chamber shield liner after recovery. Dark stained regions in FIG. 14A are no longer observed after recovery as seen in FIG. 14B.

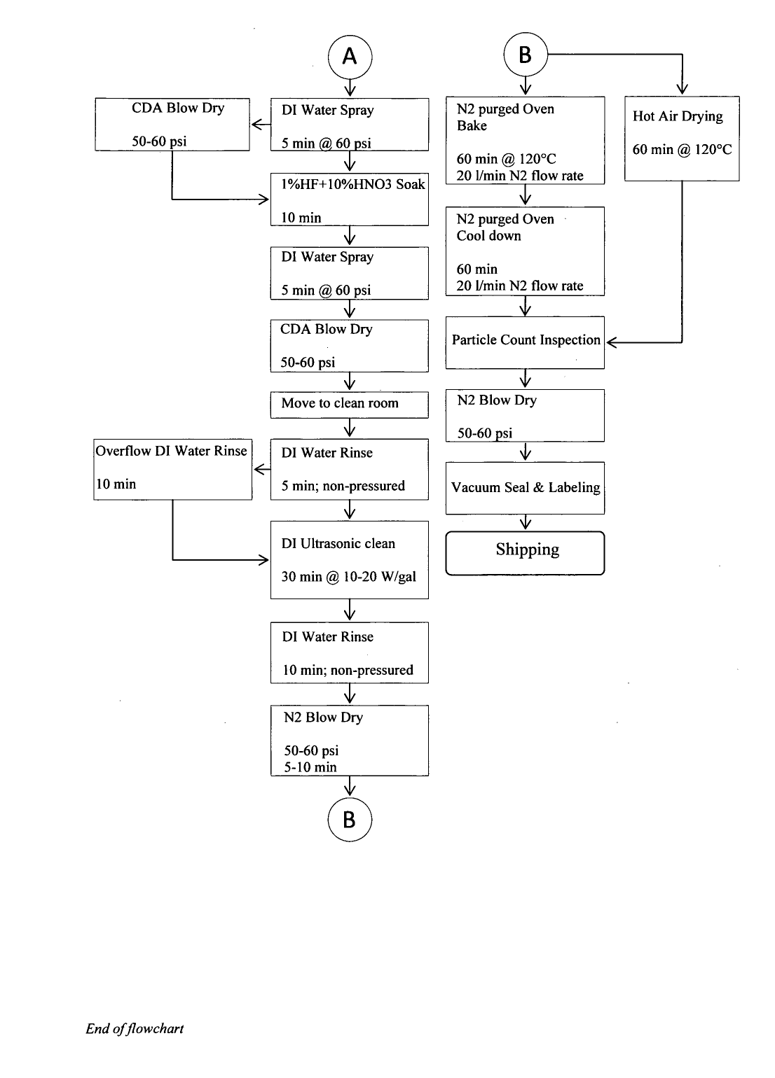

FIG. 15A shows exemplary used silicon coated baffle cooling plate before recovery, while FIG. 15B shows exemplary silicon coated baffle cooling plate after recovery. Dark stained regions in FIG. 15A are no longer observed after recovery as seen in FIG. 15B.

### 4.4. Method for Precision Cleaning and Recovery of Poly-Silicon Process Kit, for Example, the Platen Shield Ring.

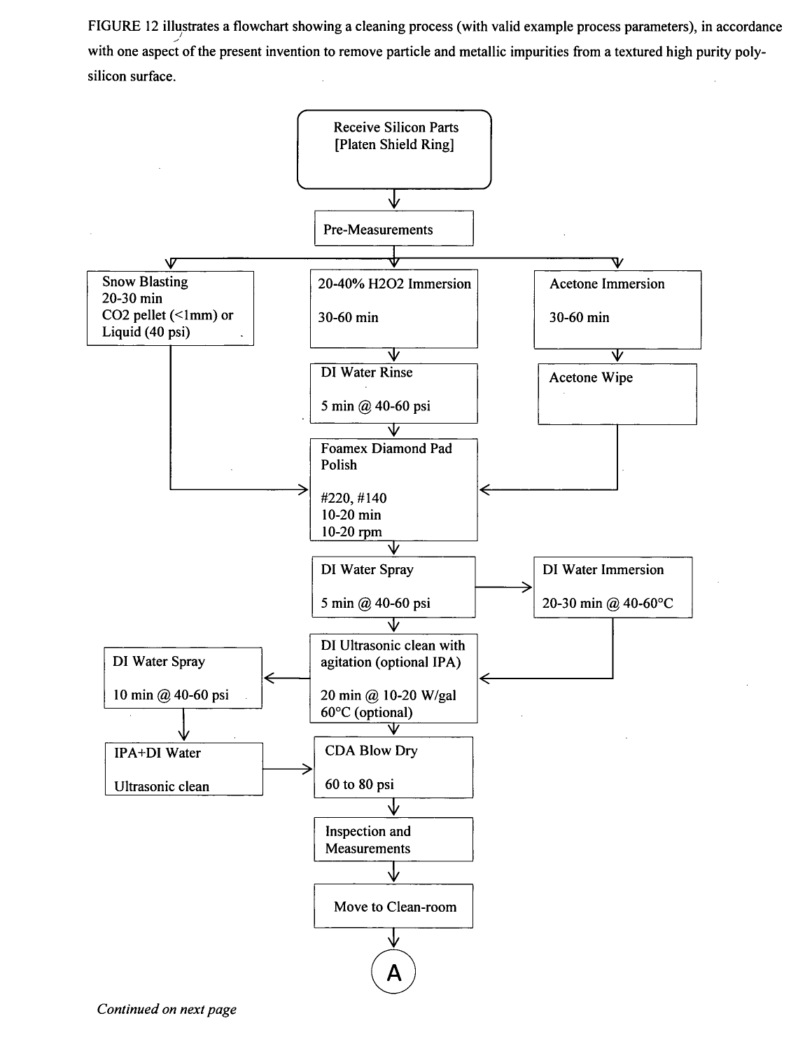

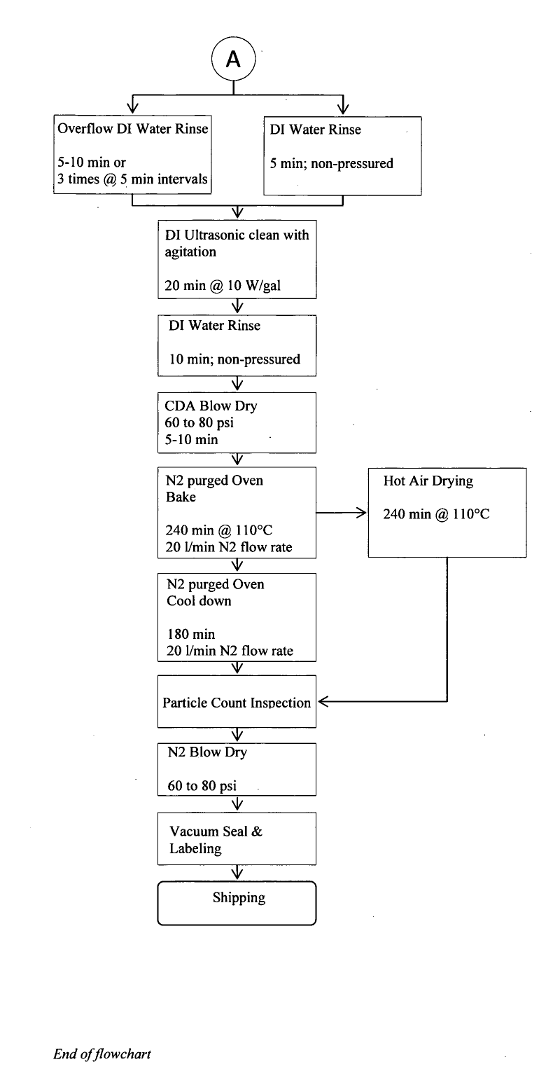

FIG. 12 illustrates the flowchart (with valid example parameters) showing a precision cleaning and recovery method, in accordance with one aspect of the present invention, to clean and remove contaminants from a poly-silicon textured surface of the platen shield ring. Note that all given process parameters in FIG. 12 pertaining to the present invention are for illustrative purpose only. As such, those of ordinary skilled in the art will recognize that said process parameters may not be construed as non-variables.

In one embodiment of the present invention, a best-known-method (BKM) for recycle cleaning and recovery process of contaminated poly-silicon process kits, for example, the platen shield ring shall include the steps of:

During the incoming acceptance inspection, the poly-silicon process kits which include the platen shield ring, are received from the customer and carefully placed on a clean inspection table and checked for surface damages and/or abnormalities. The poly-silicon surfaces shall be free of any pitting, scale, cracks and indentations, evidence of rolling, peeling or inclusions, discoloration and stains. Signs of these are documented and reported to the customer representative. Preferably, the inspection table is wiped with isopropyl alcohol prior to measurements and the surface roughness and surface resistivity measured at predetermined locations. The conditions of the poly-silicon process kits are documented as per guidelines established. Documentation will include digital photographs as well as logs of critical data.

The poly-silicon platen shield ring may be pre-cleaned with acetone and/or isopropyl alcohol. For example, the kit may be carbon dioxide (snow) blasted by directing a stream of small flakes of dry ice pellets (pellet size range <1 mm) or liquid with a pressure of 40 psi for about 20-30 minutes to remove any residue by a combination of thermal shock and physical bombardment; or immersed in acetone for 30 to 60 minutes and wiped to remove organic stains or deposits; or immersed into a solution of 20 to 40% Hydrogen Peroxide (H₂O₂) for 30 to 60 minutes and then rinsed with de-ionized water at 40 to 60 psi for 5 minutes. The platen shield ring is then blown dry with compressed dry air (ultra-filtered to 0.1 μm or better and pressured about 60 to 80 psi) to remove excess water.

Preferably, the poly-silicon surface of the platen shield ring is re-textured and recovered using a combination of mechanical and/or wet polishing methods. The re-texturing procedure (i.e. the selection and sequencing of the texturing media used), depends on the degree of contamination of the platen shield ring poly-silicon surface. If severe contamination is observed on the platen shield ring poly-silicon surface, re-texturing can begin with rough diamond grit pads (having a mean diamond grain diameter falling within the range of 0.06 μm to 0.50 μm and a Mohs hardness falling within the range of 6 to 8) (#220) until major dark contaminated stains and pitting are removed and a uniformly clean surface is achieved. If minor contamination is observed on the platen shield ring poly-silicon surface, re-texturing can begin with medium diamond grit pads (having a mean diamond grain diameter falling within the range of 0.10 μm to 0.50 μm and a Mohs hardness not lower than 9) (#140) until a uniformly clean surface is achieved. Fine diamond grit pads (having a mean grain diameter falling within the range of 0.10 μm to 2.0 μm) may be used to finish off the step. The polishing process may take 10-20 minutes depending on the level of contamination. Subsequent re-texturing may alternate between rough/medium diamond grit pads until major contaminated deposition has been removed and the surface roughness and surface resistivity are achieved.

During re-texturing, the platen shield ring is securely attached to a turntable with a rotational speed of about 20-40 rpm. A uniform, but not strong, force is applied during re-texturing with particular care exercised at the small holes area, as a strong force may cause damage to the surface of the platen shield ring.

Following re-texturing, the platen shield ring is then water-jetted with de-ionized water at 40 to 60 psi for 5 minutes and blown dry. The surface is wiped until no visible residue transfer onto the wiper is observed. The surface roughness of the platen shield ring may be measured using, for example, a surface roughness meter (non-contact laser or stylus). The surface roughness of the platen shield ring is approximately 10 to 20 μin. The surface resistivity of the platen shield ring may be measured using a multi meter with alligator clips attached, with clean room wipes place beneath the part, to a specification of <200 ohms.

The platen shield ring is preferably immersed in de-ionized water at 40 to 60° C. for 20 to 30 minutes in order to loosen particles that may be trapped in the platen shield ring. The platen shield ring may be ultrasonically cleaned in an overflowing (to facilitate effective fluid exchange) de-ionized water ultrasonic tank (with optional isopropyl alcohol) with power density set at 10 to 20 Watts/gallon for 20 minutes at about 60° C. to remove particles from the surface of the platen shield ring. The platen shield ring may be moved up and down within the ultrasonic bath during the ultrasonic cleaning in order to help remove trapped particles. The platen shield ring, including gas holes and profile, may be rinsed using de-ionized water (resistivity 2-16 Mega Ohms/cm or higher) for 10 minutes at a pressure of 40 to 60 psi. Special handling may be needed to avoid damaging or impacting the poly-silicon surface. Following the re-texturing step, the platen shield ring may be ultrasonically cleaned with a mixed solution of de-ionized water and isopropyl alcohol so as to remove soluble dopant contaminants.

Following the cleaning, the platen shield ring is inspected for damages/abnormalities (no chips, cracks, dents, discoloration, stains on surface) on the poly-silicon surface. Preferably, the inspection table is cleaned with isopropyl alcohol prior to any measurements taken. The platen shield ring is subjected to the measurement of the surface roughness at predetermined locations and is preferably between 10 and 20 μin. The platen shield ring is also subjected to the measurement of the surface resistivity at predetermined locations using a multi meter with alligator clips attached, with clean room wipe placed beneath the part, to a specification of <200 Ohms.

Preferably, the platen shield ring is moved to a class 100 clean room environment for the final cleaning. The platen shield ring is first rinsed in an overflow (to facilitate effective fluid exchange) rinse tank containing ultra pure de-ionized water (resistivity of 18 Mega Ohms/cm or higher) for about 5-10 minutes. Preferably, at least three rinses at 5 minute intervals should be done to ensure removal of all chemical cleaning solutions. Next, the platen shield ring is rinsed in an overflow rinse tank with the power density set at 10 Watts/gallon for 20 minutes and ultra pure de-ionized (resistivity of 18 Mega Ohms/cm or higher) water within a class 100 clean-room. The ultra pure de-ionized water is ultra-filtered to remove all particles down to 0.1 μm or better. The platen shield ring is checked and inspected every 10 minutes to ensure no stains or contamination exists. The platen shield ring is then rinsed in de-ionized water for 10 minutes before being blown dry with high pressured (about 60 to 80 psi) compressed dry air (dry, oil-free, and ultra-filtered to 0.1 μm or better) for 5 to 10 minutes within a class 100 clean-room environment.

In this final cleaning operation, the platen shield ring is monitored during the cleaning operation by using a Liquid Particle Counter. This monitoring method is used to ensure that the platen shield ring has achieved the predetermined cleanliness specification. When the particle count level, as measured by LPC technique, is less than 250,000 particles per cm², the platen shield ring is then rinsed in de-ionized water, and thereafter blown dry with filtered pure nitrogen gas or compressed dry air. This cleaning process can be repeated if the platen shield ring has not attained the specified levels of cleanliness.

The platen shield ring is subjected to high temperature sufficient to substantially remove all absorbed cleaning solutions as well as water vapor, chemicals and spout traps during the cleaning process. One method may involve hot air drying of the platen shield ring in a chamber at 110° C. for about 240 minutes. Alternatively, the platen shield ring is baked using a continuous nitrogen purged class 100 dust free air oven (or under a heat lamp) at 110° C. for 240 minutes with a nitrogen inlet flow rate of 20 litres per minutes. The class 100 dust free air oven should be of sufficient size to accommodate the platen shield ring and the platen shield ring should be kept away from the oven wall with jigs and fixtures. The poly-silicon process kits are then cooled in the oven with continuous pure nitrogen gas purge for 180 minutes at a flow rate of 20 litres per minute within a class 100 clean-room before being taken out of the oven.

Following the final cleaning and baking, the platen shield ring is checked and inspected for particle contamination with the QIII surface particle counter in a class 100 clean room environment to a specification of <1 particle/inch². In addition, the platen shield ring is inspected for stains, dirt, defects, fractures, scratches and cracks.

Finally, the platen shield ring is packed within a class 100 clean-room using a double-bag vacuum pack whereby the inner bag is a nylon bag of thickness 0.1 mm with clean lint free material and the outer bag is an amide and silicon-free polyethylene bag of thickness 0.12 mm. Bags are purged with pure nitrogen gas to evacuate any air. These steps are to ensure that the platen shield ring remains clean and free from damage. All sealing faces and/or knife edges are protected with clean used metal gaskets where possible. All ports are covered with strong clean new aluminum foil and plastic covers.

The platen shield ring is preferably inspected before and after precision cleaning and recovery to ensure that the recycled platen shield ring conforms to product specifications. Inspection may include measuring, for example, dimensions (e.g. thickness), silicon surface resistivity (multi meter with alligator clips with a specification of <200 ohms.), surface roughness (e.g. 10 to 20 μin or less), surface cleanliness and surface particle count. Furthermore, the PLAD plasma doping chamber performance of the recovered platen shield ring is preferably tested to ensure that the recovered platen shield ring exhibit acceptable performance. Post-process operations include testing the platen shield ring in a fully-assembled PLAD equipment, and other post-process operations that will be apparent to those skilled in the art.

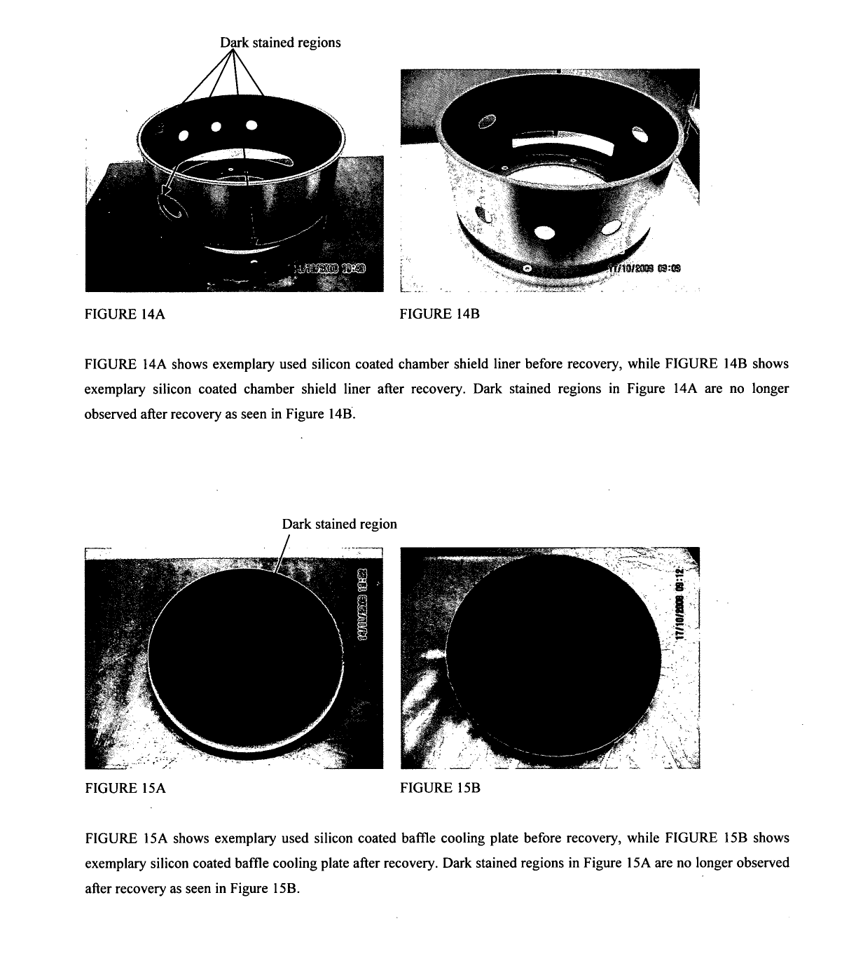

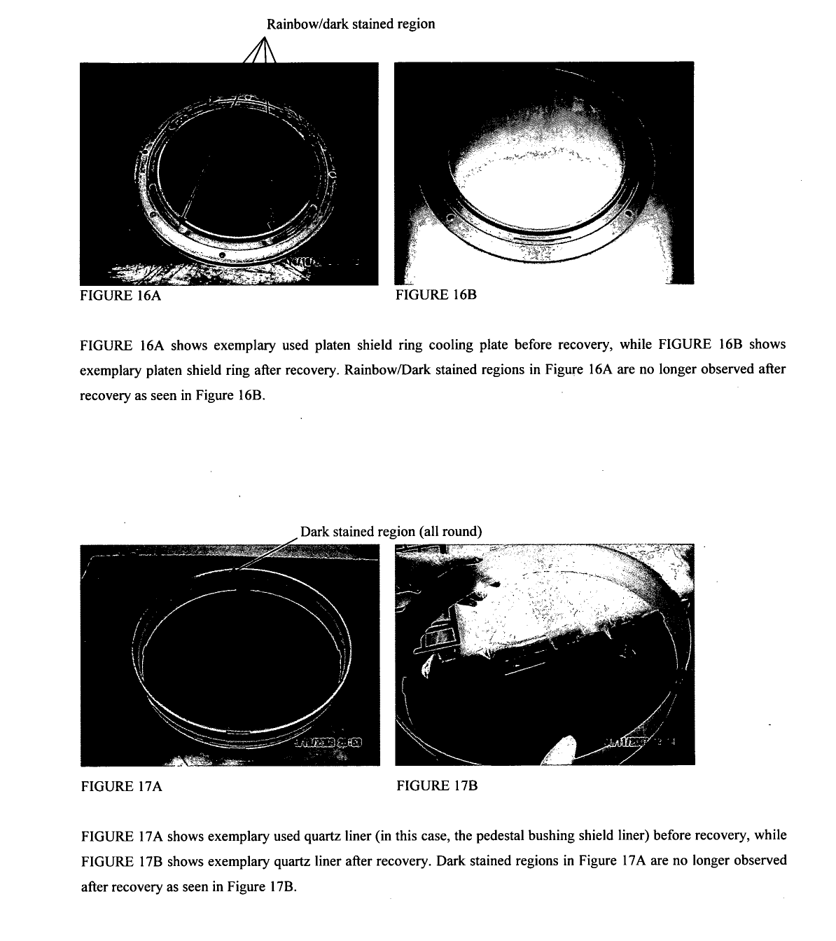

FIG. 16A shows exemplary used platen shield ring cooling plate before recovery, while FIG. 16B shows exemplary platen shield ring after recovery. Rainbow/Dark stained regions in FIG. 16A are no longer observed after recovery as seen in FIG. 16B.

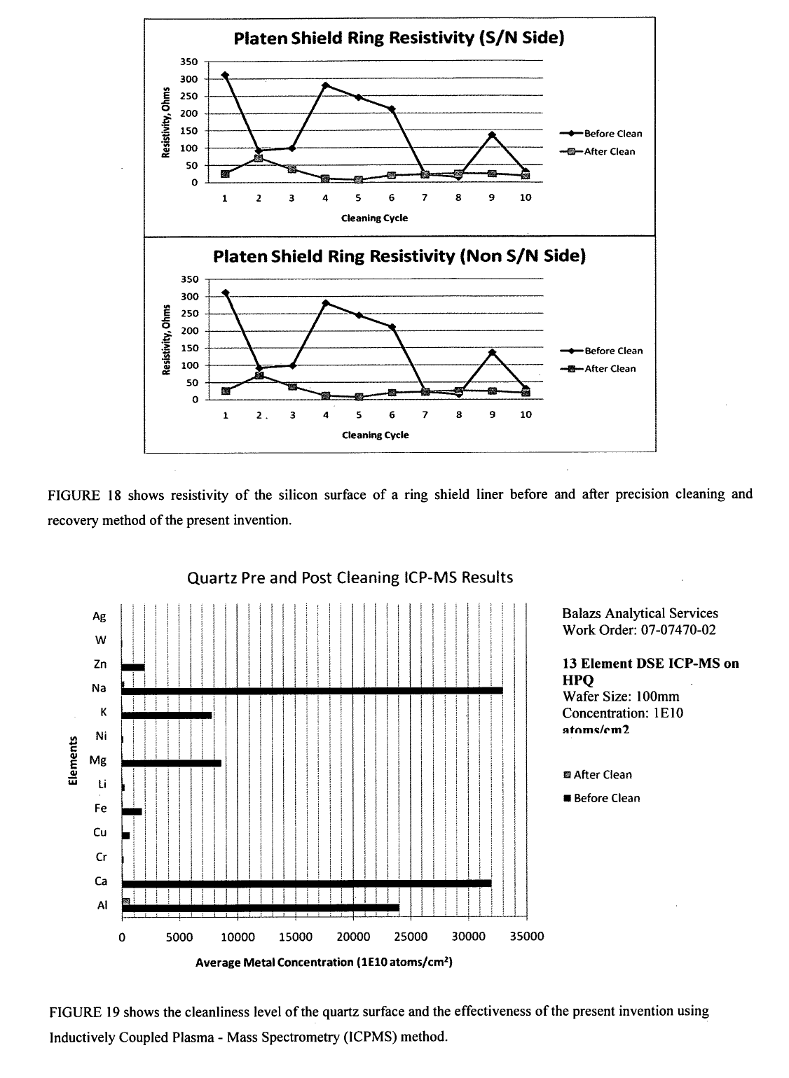

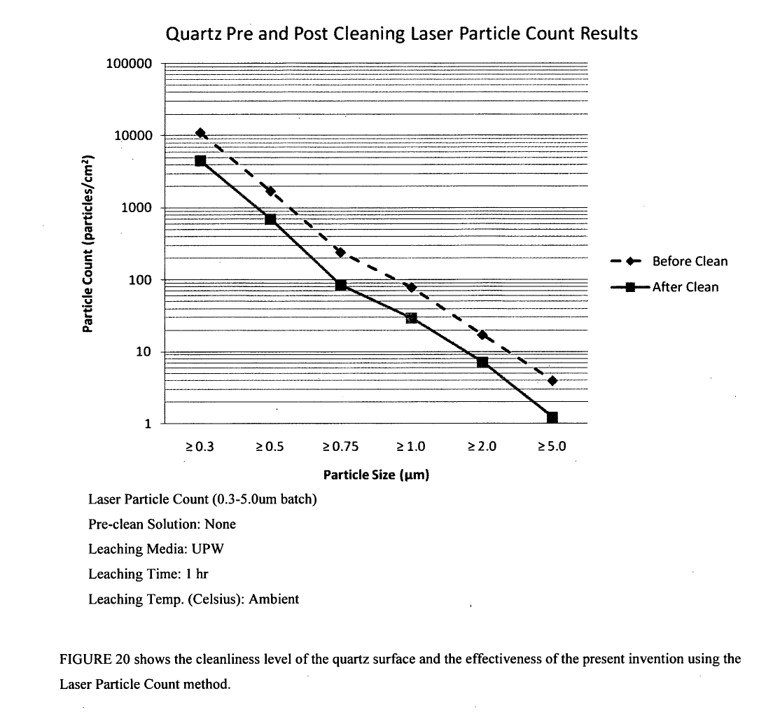

FIG. 18 shows resistivity of the silicon surface of a ring shield liner before and after precision cleaning and recovery method of the present invention.

### 4.5. Method for Precision Cleaning and Recovery of Quartz Process Kit, for Example, (a) an RF Window Shield Liner; (b) a Top Window Shield Liner; and (c) a Pedestal Bushing Shield Liner.

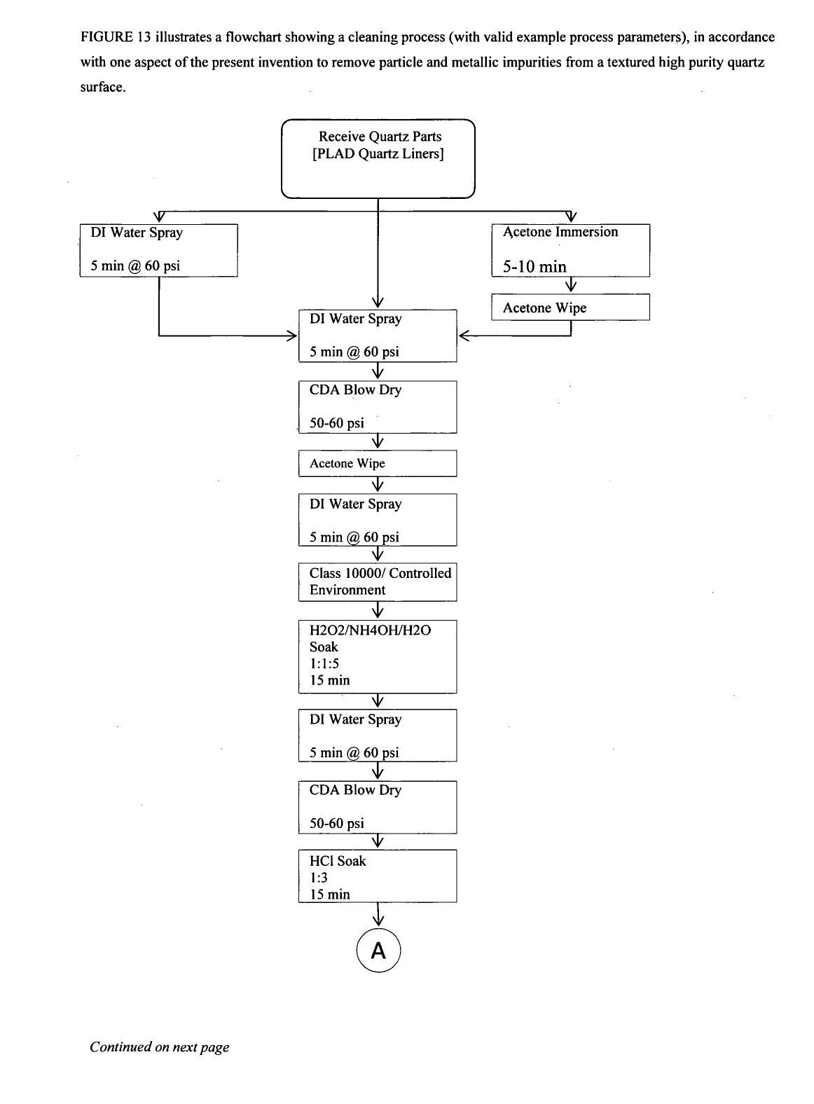

FIG. 13 illustrates the flowchart showing a precision cleaning and recovery method, in accordance with one aspect of the present invention to clean and remove contaminants from a textured quartz surface of (a) an RF window shield liner; (b) a top window shield liner; and (c) a pedestal bushing shield liner (which is made of flame polish quartz structure). Note that all given process parameters in FIG. 13 pertaining to the present invention are for illustrative purpose only. As such, those of ordinary skill in the art will recognize that said process parameters may not be construed as non-variables.

In one embodiment of the present invention, a best-known-method (BKM) for recycle cleaning and recovery process of contaminated quartz process kits such as the (a) an RF window shield liner; (b) a top window shield liner; and (c) a pedestal bushing shield liner, shall include the steps of:

During the incoming acceptance inspection, the quartz process kits that include (a) an RF window shield liner; (b) a top window shield liner; and (c) a pedestal bushing shield liner, are received from the customer and carefully placed on a clean surface and inspected for damages and/or abnormalities on quartz surface. The quartz surfaces shall be free of pitting, scale, cracks, deformation, dents, discoloration and stains. Signs of these are documented and reported to the customer representative. Preferably, the inspection table is wiped with isopropyl alcohol prior to measurements taken. Surface roughness and any critical dimensions are measured at predetermined locations. The conditions of the quartz process kits are documented as per guidelines established. Documentation will include digital photographs as well as logs of critical data.

The quartz process kits, which include (a) an RF window shield liner; (b) a top window shield liner; and (c) a pedestal bushing shield liner may be pre-cleaned with acetone and/or isopropyl alcohol if necessary. For example, the quartz process kits may be immersed (with a Teflon fixture to hold the quartz process kits) in acetone or isopropyl alcohol (IPA) solution for 5 to 10 minutes to remove organic stains. If necessary, lint-free polyester sealed wipers are used to clean the quartz process kits. Quartz process kits are then spray rinsed with de-ionized water (DIW) for 5 minutes at 60 psi and blown dry with compressed dry air (ultra-filtered to 0.1 μm or better and pressured about at about 50 to 60 psi) to remove excess water.

Preferably, the quartz process kits which include (a) an RF window shield liner; (b) a top window shield liner; and (c) a pedestal bushing shield liner are cleaned, re-textured and recovered using a combination of a three-step exact chemistry method. The three-step exact chemistry method re-textures the quartz surface by etching a surface layer of damaged or contaminated quartz to lower the particle count on said quartz surface.

The first step is to fully submerge the quartz process kits, which include (a) an RF window shield liner; (b) a top window shield liner; and (c) a pedestal bushing shield liner using a Teflon fixture into a chemical tank with an aqueous mixed-chemical solution of Hydrogen Peroxide, Ammonium Hydroxide and Water (H₂O₂:NH₄OH:H₂O) for 15 minutes until all stains have been removed wherein the amount of Hydrogen Peroxide, Ammonium Hydroxide and Water (H₂O₂:NH₄OH:H₂O) in said aqueous chemical solution is in the ratio of 1:1:5 by volume ratio based on the total volume of the solution. It is important to ensure that the chemical solution contacts all surfaces and that no portion of the quartz touches the tank. The quartz process kits are then spray rinsed with de-ionized water (DIW) for 5 minutes at 60 psi and blown dry with compressed dry air (ultra-filtered to 0.1 μm or better and pressured at about 50 to 60 psi).

The second step is to fully submerge the quartz process kits, which include (a) an RF window shield liner; (b) a top window shield liner; and (c) a pedestal bushing shield liner for 15 minutes, using a Teflon fixture with an aqueous chemical solution containing Hydrochloric Acid (HCl), in the dilution ratio of 1:3 by volume ratio based on the total volume of the solution, until all stains have been removed. It is important to ensure that the chemical solution contacts all surfaces and ensure that no portion of the quartz touches the tank. The quartz process kits are then spray rinsed with de-ionized water (DIW) for 5 minutes at 60 psi and blown dry with compressed dry air (ultra-filtered to 0.1 μm or better and pressured at about 50 to 60 psi).

The third step is to fully submerge the quartz process kits, which include (a) an RF window shield liner; (b) a top window shield liner; and (c) a pedestal bushing shield liner for 10 minutes using a Teflon fixture into a tank with aqueous mixed-chemical solution comprising of Nitric Acid and Hydrogen Fluoride (10% HNO₃ and 1% HF) aqueous mixed-acid solution wherein the amount of Hydrogen Fluoride in said aqueous mix-acid solution is from about 1% by volume based on the total volume of the solution, and the amount of Nitric Acid in said solution is from about 10% by volume, based on the total volume of the solution. The quartz process kits are then spray rinsed with de-ionized water (DIW) for 5 minutes at 60 psi and blown dry with compressed dry air (ultra-filtered to 0.1 μm or better and pressured at about 50 to 60 psi).

Fixtures for supporting the quartz process kits which includes (a) an RF window shield liner; (b) a top window shield liner; and (c) a pedestal bushing shield liner during cleaning have supporting members and base that are preferably coated with and/or made from a chemically resistant material, such as Teflon (Poly-Tetra-Fluoro-Ethylene), which is chemically resistant to acids.

Following the chemical cleaning, the quartz process kits, which include (a) an RF window shield liner; (b) a top window shield liner; and (c) a pedestal bushing shield liner are preferably transported using PE tanks filled with de-ionized water (DIW) to a class 100 clean room environment for the final cleaning. The quartz process kits are first rinsed in an overflow (to facilitate effective fluid exchange) rinse tank containing ultra pure de-ionized water (resistivity of 18 Mega Ohms/cm or higher) for 5 minutes. Preferably, at least three rinses at 5 minute intervals should be done to ensure removal of all chemical cleaning solutions. Next, the quartz process kits are rinsed in an overflow rinse tank containing ultra pure de-ionized (resistivity of 18 Mega Ohms/cm or higher) water with the power density set at a power density of 10 to 20 Watts/gallon for 30 minutes within a class 100 clean-room. The ultra pure de-ionized water is ultra-filtered to remove all particles down to 0.1 μm or better. The quartz process kits are checked and inspected every 10 minutes to make sure no stains or contamination exists. The quartz process kits are then rinsed with de-ionized water for 10 minutes before being blown dry with high pressured (at about 50 to 60 psi) nitrogen gas (dry, oil-free, and ultra-filtered to 0.1 μm or better) for 5 to 10 minutes within a class 100 clean-room environment.

In this final cleaning operation, the quartz process kits, which include (a) an RF window shield liner; (b) a top window shield liner; and (c) a pedestal bushing shield liner are monitored during the cleaning operation by using a Liquid Particle Counter. This monitoring method is used to ensure that the quartz process kits have achieved the predetermined cleanliness specification. When the particle count level, as measured by LPC, is <200,000 particles per cm², the quartz process kits are rinsed with ultra pure de-ionized water for 5 minutes and then blown dry with high pressured (at about 50 to 60 psi) nitrogen gas (dry, oil-free, and ultra-filtered to 0.1 micron or better) for 5 to 10 minutes. This cleaning process can be repeated if the quartz process kits have not attained the specified levels of cleanliness.

The quartz process kits, which include (a) an RF window shield liner; (b) a top window shield liner; and (c) a pedestal bushing shield liner, are subjected to high temperature sufficient to substantially remove all absorbed cleaning solutions as well as water vapor, chemicals and spout traps during the cleaning process. One method may involve hot air drying of the kits in a chamber at 120° C. for about 60 minutes. Alternatively, kits are baked using a continuous nitrogen purged class 100 dust free air oven (or under a heat lamp) at 120° C. for 60 minutes. The oven shall nitrogen purged from an inlet with a flow rate of 20 litres per minute. The class 100 dust free air oven should be of sufficient size to accommodate the quartz process kits and the quartz process kits should be kept away from the oven wall with jigs and fixtures. The quartz process kits are cooled in the oven for 60 minutes at a flow rate of 20 litres per minute within a class 100 clean-room before being taken out of the oven.

Following the final cleaning and baking, the quartz process kits which include (a) an RF window shield liner; (b) a top window shield liner; and (c) a pedestal bushing shield liner, are inspected for particle contamination with a QIII surface particle counter in a class 100 clean room environment to a specification of <1 particle/inch². In addition, the quartz process kits are inspected for stains, dirt, defects, fractures, scratches and cracks on the quartz surface. Preferably, the quality inspection should include checking the surface cleanliness and conditions of the quartz process kits, as well as inspecting the quartz process kits for signs of contamination, faulty cleaning or damage. The quartz process kits are visually inspected for cleanliness using a portable microscope. Preferably, the criteria for a clean quartz process kit should include measurements of the cleanliness of the quartz process kits determined using Inductively Coupled Plasma-Mass Spectrometry (ICP-MS) method to complement visual examination of the quartz kits after the cleaning procedure is completed. The quartz surface cleanliness is determined by extracting the surface contamination from a “cleaned” process kit coupon with a mixed chemical solutions of 2% ultra-pure Hydrofluoric Acid and 2% ultra-pure Hydrogen Peroxide. The extract is analyzed by Inductively Coupled Plasma-Mass Spectrometry (ICP-MS) for metal contamination such Aluminum, Calcium, Chromium, Copper, Iron, Lithium, Magnesium, Nickel, Potassium, Sodium, Zinc, Tungsten and Silver.

Finally, the quartz process kits are packed within a class 100 clean-room environment using a double-bag vacuum pack whereby the inner bag is a nylon bag of thickness 0.1 mm with clean lint free material and the outer bag is an amide and silicon-free polyethylene. bag of thickness 0.12 mm. During packaging, the inner bag is purged with nitrogen to evacuate any air. These steps are to ensure that the quartz process kits remain clean and free from damage. All seal faces and/or knife edges are protected with clean used metal gaskets where possible. All ports are covered with strong, clean and new aluminum foil and plastic covers.

The quartz process kits which consist of (a) a RF window shield liner; (b) a top window shield liner; and (c) a pedestal bushing shield liner, are preferably inspected before and after precision cleaning and recovery to ensure that the recycled quartz process kits conform to product specifications. Inspection may include measuring, for example, dimensions (e.g. thickness), surface roughness (e.g. 10 to 30 μin), surface cleanliness and surface particle count. Furthermore, the PLAD plasma doping chamber performance of the recovered quartz process kits are preferably tested to ensure that the recovered quartz process kits exhibit acceptable performance. Post-process operations include testing the quartz process kits in a fully-assembled PLAD equipment, and other post-process operations that will be apparent to those skilled in the art.

FIG. 19 shows the cleanliness level of the quartz surface and the effectiveness of the present invention using Inductively Coupled Plasma-Mass Spectrometry (ICP-MS) method. Inductively Coupled Plasma-Mass Spectrometry (ICP-MS) is a well-known method for trace element analysis because of its sub-parts-per-trillion detection limit and multi-element, multi-isotope capability. The surface cleanliness is determined by extracting the surface contamination from a process kit coupon with a mixed solution of 2% hydrofluoric acid and 2% hydrogen peroxide. This extract is then analyzed by Inductively Coupled Plasma-Mass Spectrometry (ICP-MS). The amount of metal determined is expressed in terms of the number of atoms per unit area of the sample used for extraction (atoms/cm²). The concentration of metals in the sample is determined by ICP-MS in the following manner. A small amount of a chemical reagent consisting of a 50:50 mixture of 2% ultra-pure Hydrofluoric Acid and 2% ultra-pure Hydrogen Peroxide is dropped onto the surface of the process kit coupon to be analyzed. The solution on the coupon surface is allowed to stand for about 10 minutes and then recovered. The concentration of metals is analyzed by ICP-MS, and the figures are expressed in terms of the number of metal atoms per unit area of the process kit. The apparatus used for ICP-MS were run to analyze for such metals as Aluminum, Calcium, Chromium, Copper, Iron, Lithium, Magnesium, Nickel, Potassium, Sodium, Zinc, Tungsten and Silver. The results clearly showed that the metal contaminations of the major elements were extremely low. Thus, the present invention is effective in recycle cleaning of quartz process kits.

It shall be appreciated that the apparatus for cleaning of plasma doping (PLAD) process kits in accordance with the present invention includes, but is not limited to, the equipment and facilities such as:
(a) De-ionized (DI) water: The source of de-ionized water shall have a specific resistivity of no less than 16 M Ohms-cm as determined in accordance with ASTM D1125. A proper UV light module shall be installed for bacteria control. At point of use, DI water used for rinsing and cleaning (except for drag out rinse) shall have a minimum specific resistivity of 2.0 M Ohms-cm.
(b) Compressed Nitrogen or Dry Air: Nitrogen gas or air used to dry components shall be dry, oil-free, and filtered at the point of use with a 0.1 mm filter. The filters shall be replaced regularly and a maintenance record shall be kept.
(c) Critical Chemicals: In-coming critical chemicals such as Acetone, Hydrochloric Acid (HCl), Nitric Acid (HNO₃), mixed-chemical solution of Hydrogen Peroxide, Ammonium Hydroxide and Water (H₂O₂:NH₄OH:H₂O), mixed-acids Nitric Acid and Hydrogen Fluoride (HNO₃ and HF) shall be of semiconductor grade and monitored for mobile ion/heavy metal levels. Maximum acceptable levels for ion contamination and heavy metals shall be established which correlate to the requirements. There shall be maintained records indicating in-coming chemical purity.

(d) Clean-room: A class 100 or better clean-room as defined in FED-STD-209 shall be employed for final cleaning, drying, final inspection and packaging. The operation, housekeeping, and monitoring of clean-rooms shall be in compliance with IES-RP-CC026 and IES-RP-CC018. The equipment required for this present invention include a class 100 clean room oven and class 100 clean room de-ionized (DI) water rinse tanks with ultrasonic cleaning capabilities.
(e) Process tanks: Chemical tanks for cleaning shall be monitored regularly for adequate control of chemical compositions, cleanliness and temperature. All chemical baths for cleaning shall be properly filtered and free of any visible surface film or scum. Tanks shall be covered when not in use. The chemical tanks and DI water in immersion tanks shall be properly agitated by oil-free compressed dry air or nitrogen and mechanically agitated to prevent contamination by particles or hydrocarbons. The equipment required for the present invention are: (i) one pressured water-jet rinse tank, (ii) one acetone solution tank, (iii) one mixed-chemical solution tank (iv) one HCL chemical solution tank (v) one mix-acid tank for HF and HNO3; (vi) two ultra pure de-ionized (DI) water rinse tanks with overflow and ultrasonic cleaning capabilities; (vii) two de-ionized (DI) water overflow rinse tanks and (vii) three ultra pure de-ionized (DI) water overflow rinse tanks. Preferably, process equipment shall be adequately equipped and constructed of materials that will not damage or contaminate components during processing. The tanks are fabricated from polypropylene and have sufficient dimensions to completely hold the quartz process kits and allow for submerging thereof. More preferably, the dimensions of the tanks are designed and built between 800-1000 mm in length, 800-1000 mm in width, and of sufficient height to provide at least a 300-600 mm depth of any liquid therein. In operation, the level of mixed-acids, chemical solutions or solvent in the container must be at least of sufficient quantity and depth to wet the surface of the quartz process kits to create a “cleaning” effect. The selection of the appropriate type of container or tank for the cleaning systems tends to be important. The container shall be fabricated from any material that remains un-corroded in the presence of mixed-acids or chemical solutions. Preferably, the container shall be fabricated of heat resistant glass or stainless steel. The primary constituents of the rinse baths may include heavy metal waste concentrations and as such, acid bath solution and rinse water should be disposed in an environmentally safe method.

In view of the foregoing, it will be appreciated that, the recycle cleaning and recovery of textured process kits include mechanical polishing methods, chemical methods, and/or a combination of these methods. In addition, the methods for determining the cleanliness of the process kits as well as the apparatus, fixtures and facilities for the implementation of this present invention are incorporated herein.

In addition, it will be appreciated that a certified precision cleaning and recovery process can be established, documented and maintained. It will therefore be appreciated that the recycle cleaning and recovery process can be performed with the apparatus and facilities capable of monitoring, controlling and recording all critical parameters that affect the quality. These parameters include, but are not limited to: processing time; composition and temperature of chemical baths; method of rinsing; resistivity of rinsing water; operation of ultrasonic equipment.

Having thus described illustrative embodiments of the invention, it will be apparent that various alterations, modifications and improvements will readily occur to those skilled in the art. Such obvious alterations, modifications and improvements, though not specifically described above, are nonetheless intended to be implied and are within the spirit and scope of the invention. While the present invention has been described in terms of several preferred embodiments, there are many alterations, permutations, and equivalents which may fall within the scope of this invention. It should also be noted that there are many alternative ways of implementing the methods and apparatus of the present invention. It is therefore intended that the following appended claims be interpreted as having including all such alterations, permutations, and equivalents falling within the true spirit and scope of the present invention.

What is claimed is:

1. A set of plasma doping process kits used for semiconductor material processing, whereby the set of plasma doping (PLAD) process kits are capable of shielding and protecting the interior surface of a plasma doping chamber from deterioration and unwanted particles, condensed contaminants and metal dopant materials generated in the chamber; the set of PLAD process kits comprising of;
(a) a chamber shield liner component made of aluminum material and having the inner surface coated with high purity silicon material, the silicon textured surface having a surface roughness average Ra from about 200 to 300 μin, and a coating thickness of about 200 to 400 μm;
(b) a cooling baffle plate component made of aluminum material and having a silicon coated textured surface, the silicon textured surface having a surface roughness average Ra from about 200 to 300 μin, and a coating thickness of about 150 to 300 μm;
(c) a platen shield ring component made of poly-silicon material and having a textured surface about the substrate, the textured surface having a surface roughness average Ra from about 10 to 20 μin, and a surface resistivity of less than 200 ohms;
(d) an RF window shield liner component, with a thickness of 0.080 inch, made of quartz material and having a textured surface, the textured surface having a surface roughness average Ra from about 10 to 30 μin;
(e) a top window shield liner component, with a thickness of 0.080 inch, made of quartz material and having a textured surface, the textured surface having a surface roughness average Ra from about 10 to 30 μin;
(f) a pedestal bushing shield liner component, with a thickness of 0.167 inch, made of quartz material and having a textured surface, the textured surface having a surface roughness average Ra from about 10 to 30 μin;

2. The chamber shield liner component according to claim 1(a), wherein the chamber shield liner component is capable of shielding the interior surface of a plasma doping chamber from deterioration and unwanted particles, condensed contaminants and metal dopant materials. The chamber shield liner comprises: a metal base shield structure including, at least, a first surface. The structure comprises a textured surface of high-purity silicon coated thereof by thermal spraying on the first surface of the shield. The high-purity silicon coating comprises, in wt. %, at least 99.99% Si and/or ≦0.01% total transition elements. The first surface on which the silicon coating is disposed is an electrically-conductive surface. The silicon coating comprises a process-exposed inner surface of the component.

3. The chamber shield liner component according to claim 1(a), wherein the aluminum base shield liner is a structure adapted to, at least, partially cover the interior surface in the chamber and comprises, in wt. %, at least 99.00% Al, ≦0.10% Cu, ≦0.10% Mg, ≦0.015% Mn, ≦0.02% Cr, ≦0.07% Fe, ≦0.025% Zn, ≦0.06% Si, ≦0.015% Ti, and ≦0.015% total residual elements. The shield liner structure comprises a textured interior surface coating of high-purity silicon comprising at least 99.99 wt. % Si and ≦0.01 wt. % total transition elements, in which the silicon textured surface has a surface roughness average Ra from about 200 to 300 μin, and a coating thickness of about 200 to 400 μm.

4. The cooling baffle plate component according to claim 1(b), wherein the cooling baffle plate component serves as an upper shielding area that shields the top sidewall of a plasma doping chamber from deterioration and unwanted particles, condensed contaminants and metal dopant materials. The cooling baffle plate component comprises: a metal base shield structure including, at least, a first surface. The structure comprises a textured surface of high-purity silicon coated by thermal spraying on the first surface of the shield. The high-purity silicon coating comprises, in wt. %, at least 99.99% Si and/or ≦0.01% total transition elements. The first surface on which the silicon coating is disposed is an electrically-conductive surface. The silicon coating comprises a process-exposed inner surface of the component.

5. The cooling baffle plate component according to claim 1(b), wherein the aluminum base shield liner is a structure adapted to at least partially cover the interior surface in the chamber and comprises, in wt. %, at least 99.00% Al, ≦0.10% Cu, ≦0.10% Mg, ≦0.015% Mn, ≦0.02% Cr, ≦0.07% Fe, ≦0.025% Zn, ≦0.06% Si, ≦0.015% Ti, and ≦0.015% total residual elements. The cooling baffle plate structure comprises a textured interior surface coating of high-purity silicon comprising at least 99.99 wt. % Si and ≦0.01 wt. % total transition elements, in which the silicon textured surface has a surface roughness average Ra from about 200 to 300 μin, and a coating thickness of about 150 to 300 μm.

6. The platen shield ring component according to claim 1(c), wherein the platen shield ring component has a unique edge with a radial inner portion that covers the upper surface of the support platen to reduce the exposure of the platen to the plasma. In addition, it also prevents deposition of doped material onto the platen and prevents the plasma doping chamber from deterioration and unwanted particle contamination. The platen shield ring component comprises: a high-purity poly-silicon material comprising, in wt. %, at least 99.99% Si and/or ≦0.01% total transition elements; wherein the platen shield ring structure is a high-purity poly-silicon annular ring with a textured surface which encircles the wafer. The textured surface has a surface roughness average Ra from about 10 to 20 μin, and a surface resistivity of less than 200 ohms.

7. The RF window shield liner component according to claim 1(d), wherein the RF window shield liner component serves to shield and reduce contamination of the doped material on the walls of the plasma doping chamber; and redirect the gas flow in the chamber to a region above the wafer. The RF window shield liner component comprises: a high-purity quartz material comprising, in wt. %, at least 99.99% Si and/or ≦0.01% total transition elements. The RF window shield liner structure comprises a flamed polished annular quartz ring with a thickness of about 0.080 inches having a textured surface with a surface roughness average Ra from about 10 to 30 μin.

8. The top window shield liner component according to claim 1(e), wherein the top window shield liner component serves to shield and reduce contamination of the doped material on the upper side chamber wall of the plasma doping chamber. The top window shield liner component comprises: a high-purity quartz material comprising, in wt. %, at least 99.99% Si and/or ≦0.01% total transition elements. The top window shield liner structure comprises a flamed polished annular quartz tube with a thickness of about 0.080 inches and having a textured surface with a surface roughness average Ra from about 10 to 30 μin.

9. The pedestal bushing shield liner component according to claim 1(f), wherein the pedestal bushing shield liner component serves to shield and reduce contamination of the doped material on the platen support structure; to reduce the exposure of the platen to the plasma; and also prevent deposition of doped material onto the platen of the plasma doping chamber. The pedestal bushing shield liner component comprises: a high-purity quartz material comprising, in wt. %, at least 99.99% Si and/or ≦0.01% total transition elements. The pedestal bushing shield liner structure comprises a flamed polished annular quartz tube with a thickness of about 0.167 inches having a textured surface with a surface roughness average Ra from about 10 to 30 μin.

10. A method of precision cleaning and recovery of the silicon coated aluminum process kits of a plasma doping chamber; the silicon coated aluminum process kits comprising a chamber shield liner component and a cooling baffle plate component, both having a plasma-exposed silicon coated surface; The method comprises:
(a) inspection and documentation of the silicon coated aluminum process kits comprising of a chamber shield liner component and a cooling baffle plate component, including the silicon coated and non-silicon coated surfaces for damages, peeling, discoloration, stains and/or abnormalities;
(b) treatment of the silicon coated aluminum process kits to remove any preliminary residues and foreign materials by a combination of thermal shock and physical bombardment method selected from the group consisting of water-jetting and/or carbon dioxide blasting method and/or combinations thereof; wherein the water-jetting method comprises of de-ionized water of suitable pressure between 60 to 80 psi for a duration of time about 10 minutes; wherein the carbon dioxide blasting method comprises of a stream of small flakes of dry ice pellets of size range less than 1 mm of suitable pressure for a duration of time between 20-30 minutes;
(c) contact of the silicon coated aluminum process kits with a cleaning solution to remove organic stains; wherein the cleaning solution comprises of a solution of acetone and/or isopropyl alcohol and/or Hydrogen Peroxide (H₂O₂) of sufficient volume of between 20% to 40% for a duration of time between 30 to 60 minutes; followed by a spray rinse with de-ionized water at a sufficient pressure of about 60 psi and for a period of time of about 5 minutes;
(d) texturing of the silicon coated interior surface by a method selected from the group consisting of wet polishing and/or wet mechanical blasting method and/or combinations thereof; wherein the silicon coated surface is re-textured and recovered using the wet polishing method with a texturing media of different abrasive diamond grained pads comprising: (a) first rough abrasive diamond grains, which have a mean diamond grain diameter falling within the range of 0.06 μm to 0.50 μm and a Mohs hardness falling within the range of 6 to 8; (b) second medium abrasive diamond grains, which have a mean diamond grain diameter falling within the range of 0.10 μm to 0.50 μm and a Mohs hardness not lower than 9, and; (c) final fine diamond grains, which have a mean grain diameter falling within the range of 0.10 μm to 2.0 μm or a combinations thereof. The silicon coated surface is re-textured and recovered using the wet blasting method with suitable texturing media of silicon oxide beads of 150 to 200 μm, at a pressure of 40 psi and a distance of 30 cm until deposition is removed and the surface roughness is achieved;
(e) treatment of the silicon coated aluminum process kits to remove particles from the silicon coated surface by a method selected from the group consisting of hot de-ionized water rinsing and/or a cleaning solution and/or ultrasonic agitation of sufficient power density and/or carbon dioxide blasting method and/or combinations thereof; wherein the silicon coated aluminum process kits are immersed in hot de-ionized water at temperature of between 40° C. to 60° C. for a duration of time about 20 to 30 minutes in order to loosen particles that may be trapped in the silicon coated kits. The silicon coated kits are ultrasonically cleaned with de-ionized water or with a mixed solution of de-ionized water and isopropyl alcohol in an overflowing ultrasonic tank of sufficient power density of about 10 to 20 Watts per gallon for a duration of time of about 20 minutes to remove particles and soluble dopant contaminants;
(f) treatment of the silicon coated aluminum process kits within a class 100 clean-room environment to ensure removal of all chemical cleaning solutions particles from the surface of the silicon coated aluminum process kits by a method selected from the group consisting of ultra pure de-ionized water rinsing and/or ultrasonic agitation of sufficient power density and/or combinations thereof; wherein the silicon coated aluminum process kits are first rinsed in an overflow rinse tank containing ultra pure de-ionized water for a duration of time about 5 to 10 minutes, followed by an ultrasonic cleaning in an overflow ultrasonic tank of sufficient power density of about 10 Watts per gallon for about 20 minutes. This is followed by a final rinse with ultra pure de-ionized water for about 10 minutes within a class 100 clean-room wherein the silicon coated aluminum process kits are oriented with the silicon coated surface facing downward during application of the final cleaning step;
(g) monitoring of the cleanliness of the silicon coated aluminum process kits within a class 100 clean-room environment to ensure that the kits have achieved the predetermined cleanliness specification; wherein the silicon coated aluminum process kits are monitored online during the cleaning by using a Liquid Particle Counter to ensure that the kit has achieved the predetermined cleanliness specification of less than 500,000 particles per cm²;
(h) subjecting the silicon coated aluminum process kits within a class 100 clean-room environment to a high temperature sufficient to remove all absorbed cleaning solutions as well as water vapor, chemicals and spout traps during the cleaning process; wherein the silicon coated aluminum process kits are subjected to a temperature of about 110° C. for about 240 minutes with a continuous nitrogen gas purge of adequate flow rate of about 20 litres per minute, and then cooled in the oven with continuous pure nitrogen gas purge at a suitable flow rate of 20 litres per minute for a about 180 minutes within a class 100 clean-room before being taken out wherein the silicon coated aluminum process kits are oriented with the silicon coated surface facing downward during application of temperature baking step;
(i) check of the silicon coated surface for particle contamination within a class 100 clean-room environment and inspecting for possible stains, dirt, defects and damages; wherein the particle contamination has a specification of less then one particle per inch²;
(j) packing of the silicon coated aluminum process kits within a class 100 clean-room environment using double bags, nitrogen gas purging and vacuum sealing method; wherein the nylon bag of thickness 0.1 mm with clean lint free material and the outer bag is an amide and silicon-free polyethylene bag of thickness 0.12 mm.

11. A method of precision cleaning and recovery of the poly-silicon process kit of a plasma doping chamber; the poly-silicon process kit of comprising of the platen shield ring component and having a plasma-exposed silicon surface. The method comprises:
(a) inspection and documentation of the poly-silicon process kit comprising the platen shield ring component, including the silicon coated and non-silicon coated surface for damages, peeling, discoloration, stains and/or abnormalities;
(b) treatment of the poly-silicon process kit to remove any preliminary residue and foreign material by a carbon dioxide blasting method comprising a stream of small flakes of dry ice pellets of size range less than 1 mm of suitable pressure for a duration between 20-30 minutes;
(c) contact of the poly-silicon process kit with a cleaning solution to remove organic stains; wherein the cleaning solution comprises of solution of acetone and/or isopropyl alcohol and/or Hydrogen Peroxide (H₂O₂) of sufficient volume of between 20% to 40% for a duration between 30 to 60 minutes; and then spray rinsed with de-ionized water for at a sufficient pressure of about 60 psi and for a period of about 5 minutes;
(d) texturing the poly-silicon surface by a method selected from the group consisting of wet polishing and/or wet mechanical blasting method and/or combinations thereof; wherein the poly-silicon surface is re-textured and recovered using the wet polishing method with a texturing media of different abrasive diamond grains pads comprising: (a) first rough abrasive diamond grains, which have a mean diamond grain diameter falling within the range of 0.06 μm to 0.50 μm and a Mohs hardness falling within the range of 6 to 8; (b) second medium abrasive diamond grains, which have a mean diamond grain diameter falling within the range of 0.10 μm to 0.50 μm and a Mohs hardness not lower than 9, and; (c) final fine diamond grains, which have a mean grain diameter falling within the range of 0.10 μm to 2.0 μm or combinations thereof; until deposition is removed and the surface roughness average Ra of about 10 to 20 μin, and a surface resistivity of less than 200 ohms is achieved;
(e) treatment of the poly-silicon process kit to remove particles from the poly-silicon surface by a method selected from the group consisting of hot de-ionized water rinsing and/or a cleaning solution and/or ultrasonic agitation of sufficient power density and/or carbon dioxide blasting method and/or combinations thereof; wherein the poly-silicon process kit is immersed in hot de-ionized water at temperature of between 40° C. to 60° C. for a duration of time about 20 to 30 minutes in order to loosen particles that may be trapped in the poly-silicon process kit. The the poly-silicon process kit is ultrasonically cleaned with de-ionized water or with a mixed solution of de-ionized water and isopropyl alcohol in an overflowing ultrasonic tank of sufficient power density of about 10 to 20 Watts per gallon for a duration of about 20 minutes to remove particles and soluble dopant contaminants;
(f) treatment of the poly-silicon process kit within a class 100 clean-room environment to ensure removal of all chemical cleaning solutions particles from the poly-silicon surface by a method selected from the group consisting of ultra pure de-ionized water rinsing and/or ultrasonic agitation of sufficient power density and/or combinations thereof; wherein the poly-silicon process kit is first rinsed in an overflow rinse tank containing ultra pure de-ionized water for a duration of about 10 minutes, followed by an ultrasonic cleaning in an overflow ultrasonic tank of sufficient power density of about 10 Watts per gallon for a duration of about 20 minutes. This is followed by a final rinse with ultra pure de-ionized water for a period of about 10 minutes within a class 100 clean-room;
(g) monitoring of the cleanliness of the silicon poly-silicon process kit within a class 100 clean-room environment to ensure that the poly-silicon process kit has achieved the predetermined cleanliness specification; wherein the poly-silicon process kit are monitored online during the cleaning by using a Liquid Particle Counter to ensure that the kit has achieved the predetermined cleanliness specification of less than 250,000 particles per cm²;
(h) subjecting the poly-silicon process kit within a class 100 clean-room environment to a high temperature sufficient to remove all absorbed cleaning solutions as well as water vapor, chemicals and spout traps during the cleaning process; wherein the poly-silicon process kit is subjected to a temperature of about 110° C. for about 240 minutes with a continuous nitrogen gas purge of adequate flow rate of about 20 litres per minute, and then cooled in the oven with continuous pure nitrogen gas purge at a suitable flow rate of 20 litres per minute for about 180 minutes within a class 100 clean-room before being taken out;
(i) check of the poly-silicon surface for particle contamination within a class 100 clean-room environment and inspecting for possible stains, dirt, defects and damages; wherein the particle contamination has a specification of less then one particle per inch²;
(j) packing of the poly-silicon process kit within a class 100 clean-room environment using double bags, nitrogen gas purging and vacuum sealing method; wherein the nylon bag of thickness 0.1 mm with clean lint free material and the outer bag is an amide and silicon-free polyethylene bag of thickness 0.12 mm.

12. A method of precision cleaning and recovery of the quartz process kits of a plasma doping chamber; the quartz process kits comprising of (i) an RF window shield liner component; (ii) a top window shield liner component; and
(iii) a pedestal bushing shield liner component, all having a plasma-exposed surface. The method comprises:
(a) inspection and documentation of the quartz process kits comprising a chamber shield liner component and a cooling baffle plate component (including the silicon coated and non-silicon coated surface) for damages, peeling, discoloration, stains and/or abnormalities;
(b) contact of the quartz process kits with a cleaning solution to remove organic stains; wherein the cleaning solution comprises of a solution of acetone and/or isopropyl alcohol duration of time between 5 to 10 minutes, and then spray rinsed with de-ionized water for at a sufficient pressure for a period of time about 5 minutes;
(c) texturing of the quartz process kits which include (i) an RF window shield liner component; (ii) a top window shield liner component; and (iii) a pedestal bushing shield liner component by a three-step exact chemistry method;
wherein the quartz surface is cleaned, re-textured and recovered using a three-step exact chemistry method comprising: (a) Firstly, an aqueous mixed-chemical solution of Hydrogen Peroxide, Ammonium Hydroxide and De-ionized Water (H₂O₂:NH₄OH:H₂O) for a sufficient period of time about 15 minutes wherein the amount of the said aqueous chemical solution is in a volume ratio of 1:1:5 based on the total volume of the solution; and then spray rinsed with de-ionized water of suitable pressure; (b) Secondly, an aqueous chemical solution containing Hydrochloric Acid (HCl) for a sufficient period of time about 15 minutes wherein the amount of the said aqueous chemical solution is in a volume ratio of 1:3 based on the total volume of the solution; and then spray rinsed with de-ionized water of suitable pressure; (c) Finally, an aqueous mixed-chemical solution comprising 10% Nitric Acid (HNO₃) and 1% Hydrogen Fluoride (HF) aqueous mixed-acid solution for a sufficient period of time about 10 minutes; and then spray rinsed with de-ionized water of suitable pressure;
(d) treatment of the quartz process kits which include (i) an RF window shield liner component; (ii) a top window shield liner component; and (iii) a pedestal bushing shield liner component within a class 100 clean-room environment to ensure removal of all chemical cleaning solutions particles from the surface by a method selected from the group consisting of ultra pure de-ionized water rinsing and/or ultrasonic agitation of sufficient power density and/or combinations thereof. The quartz process kits are first rinsed in an overflow rinse tank containing ultra pure de-ionized water for a duration of about 10 minutes, followed by an ultrasonic cleaning in an overflow ultrasonic tank of sufficient power density of about 10 Watts per gallon for a duration of about 30 minutes. This is followed by a final rinse with ultra pure de-ionized water for a period of about 10 minutes within a class 100 clean-room;
(e) monitoring the cleanliness of the quartz process kits within a class 100 clean-room environment to ensure that the kits have achieved the predetermined cleanliness specification; wherein the quartz process kits are monitored online during the cleaning by using a Liquid Particle Counter to ensure that the quartz kits have achieved the predetermined cleanliness specification of less than 200,000 particles per cm²;
(f) subjecting the quartz process kits within a class 100 clean-room environment to a high temperature sufficient to remove all cleaning solutions and chemicals during the cleaning process; wherein the quartz process kits are subjected to a temperature of about 120° C. for about 60 minutes with a continuous nitrogen gas purge of adequate flow rate of about 20 litres per minute, and then cooled in the oven with continuous pure nitrogen gas purge at a suitable flow rate of 20 litres per minute for a about 60 minutes within a class 100 clean-room before being taken out;
(g) check of the quartz surface for particle contamination within a class 100 clean-room environment and inspecting for possible stains, dirt, defects and damages; wherein the particle contamination has a specification of less then one particle per inch²;
(h) packing of the quartz process kits within a class 100 clean-room environment using double bags, nitrogen gas purging and vacuum sealing method; wherein the nylon bag of thickness 0.1 mm with clean lint free material and the outer bag is an amide and silicon-free polyethylene bag of thickness 0.12 mm.
